(19) United States
(12) Patent Application Publication
(10) Pub. No.: US 2013/0325686 A1
(43) Pub. Date: Dec. 5, 2013

(54) ANONYMOUS TRANSACTION PLATFORM

(71) Applicants: Robert Howes, Romford (GB); Usman Khan, Ilford (GB)

(72) Inventors: Robert Howes, Romford (GB); Usman Khan, Ilford (GB)

(73) Assignee: Algomi Ltd., London (GB)

(21) Appl. No.: 13/879,801

(22) PCT Filed: Dec. 19, 2011
(86) PCT No.: PCT/IB11/03092

§ 371 Date: Aug. 16, 2013

Related U.S. Application Data
(63) Continuation of application No. 13/034,029, filed on Feb. 24, 2011.

(30) Foreign Application Priority Data
Dec. 17, 2010 (GB) 1021468.2

(51) Int. Cl. G06Q 40/04

(52) U.S. Cl. CPC G06Q 40/04
USPC 705/37

(57) ABSTRACT

A computer implemented method to anonymise transactions conducted via a trading platform between a clearing agent in communication with a trading database, and a client terminal, the method comprising: identifying the client terminal with an anonymised client identifier; the clearing agent receiving from a client terminal, as an order, a request to buy or sell a quantity of financial instrument and assigning an anonymised order identifier to the request; for each anonymised order identifier the trading database identifying identical or similar financial instruments, and their quantity, offered by a plurality of other users for the financial instrument in the request and assigning a weighted score of the likelihood of a match between the identified instruments and the requested instrument; presenting on the client terminal, as a trade offer anonymised information of the weighted score of the likelihood of a match between the requested and each of a plurality of identified financial instruments; and indicating via the client terminal if one or more of the trade offers is to be negotiated or accepted.

### TECHNICAL FIELD OF THE INVENTION

The present invention relates to a computer system and platform for efficiently conducting anonymised transactions and which minimises the amount of identifiable data sent in a transaction thus improving the security of the system.

### BACKGROUND OF THE INVENTION

This invention is a computer implemented method and system that enables financial institutions, acting as clearing agents, to offer a liquidity pool of financial instruments to their clients (investors) leveraging a platform that intelligently identifies orders for similar instruments as relevant execution opportunities. The aim is to increase the opportunity for clients to successfully negotiate and execute trades, and do so anonymously.

A key challenge faced by investors looking to trade financial instruments is overcoming reduced liquidity, the causes of which include: 1) fragmentation across multiple markets, 2) fragmentation across a large instrument universe and 3) attempting to trade an illiquid instrument. A further challenge is that in certain types of trading it is desirable to be able to trade in such instruments anonymously.

Reduced liquidity has been largely addressed for the equity securities market, whereby registered stock exchanges have been created enabling equities to be traded by various investors on the same platform. However, a comprehensive solution for trading many other asset types like over the counter (OTC) bespoke financial instruments, such as bonds, has yet to surface largely due to the three causes of reduced liquidity described above. Bonds, as part of the debt market, have many varying parameters such as maturity dates, ratings, coupon rates, duration etc. These parameters create a large bond universe and this together with the fact that there isn't a centralized exchange for bonds, results in trading opportunities between investors being greatly reduced. These issues are further compounded when attempting to trade illiquid financial instruments or place orders for large quantities as this introduces an increased exposure to price sensitivity, especially if trying to do both.

In order to address market fragmentation for these types of financial instruments investors have looked to brokers and sales people who have access to a more comprehensive distribution network of liquidity. However, the issue of market fragmentation still remains as although a broker may have access to numerous sources of liquidity it is very time consuming to check these all. Electronic platforms have been built to help automate some of the cross-matching that brokers and sales people do, and even enable investors to directly trade financial instruments but so far these have been constrained to only allow exactly the same instrument to automatically match and trade, often additionally enforcing that bid/offer prices meet a specified level. While manual cross-matching as performed by sales people and brokers can be improved by identifying related liquidity, the effectiveness of such approaches is limited by the scale of the problem. With orders fragmented across so many instruments and multiple markets the task is extremely onerous and error prone in that it even if a non-exact cross-match is found, it is not necessarily the best available.

In addition to the above difficulties, current methods of trading such financial products via financial institutions and brokers leaves room for error that market information can be leaked which in turn may negatively impact the investors' execution prices. Existing software platforms share this limitation by forcing investors to reveal themselves, along with the details of their orders. The recent credit crisis has seen a rise in assets being classified as “toxic”, and many investors are concerned about the price sensitivity of trading these assets, particularly when doing so for large quantities, yet are limited in their options to mitigate this risk.

Furthermore, the present systems contribute to information leakage with details of buyers/sellers, quantities and prices traded being presented. Such information in the prior art is required to complete the trade. Accordingly, certain details regarding a trade are immediately known to any interested parties.

Accordingly to address some of the above problems there is provided a method and apparatus for improving available liquidity using crossing algorithms that intelligently identify orders for similar instruments as relevant execution opportunities. There is also provide a method and apparatus to allow the investors to negotiate on and execute these instruments anonymously with a minimum of identifiable information being presented to the investors.

### BRIEF SUMMARY OF THE INVENTION

The invention provides a computer-based method and system for intelligently matching buy and sell orders of financial instruments providing increased opportunities to anonymously negotiate and trade these orders for clients (investors). As the platform is not constrained by the conventional restriction that orders must be for identical instruments, it is able to increase liquidity by identifying execution opportunities that existing markets cannot, while employing an anonymous negotiation process that minimizes information leakage to mitigate disruption to market prices.

The invention enables a financial institution or broker, acting in the capacity of a clearing agent (CA), to host the application and offer a liquidity pool where their clients can anonymously contribute orders for a financial instrument. All orders representing instruments with the same asset class will collectively represent an order universe, and the aim of the software is to analyze the liquidity available in the order universe to intelligently identify execution opportunities that conventional markets cannot; enabling clients to negotiate on and execute these opportunities.

For each order universe, configurable crossing algorithms are defined that intelligently quantify the propensity for an order pair to trade, by comparing their parameters and those of their instruments, as relevant to the specific instrument asset class and markets in which they trade. A fully comprehensive analysis is achieved by generating crossing scores for each order in the order universe against all others, across each configured crossing algorithm. By finding the highest crossing score for each order, the software presents clients with a potential execution opportunity with the highest propensity to trade, that will be relevant to the client even if it represents an order for a different instrument. The software is also responsible for tracking all changes in the order universe that have an impact on the generated crossing scores to ensure these are updated accordingly.

In this way the software aims to improve liquidity when trading financial instruments, and this is of greatest value where liquidity is limited, for example when: 1) liquidity is fragmented across multiple markets; 2) liquidity is fragmented across a large instrument universe; 3) attempting to trade an illiquid instrument.

Whilst this application can be used for any financial instrument, it is particularly suited to those that have many parameters, resulting in a large universe of unique instruments. This is particularly true for those traded over the counter (OTC) such as corporate bonds, whose parameters include coupon rate, maturity, issuer, rating, among many others, and result in many bonds with slightly varying attributes existing in the market. This large universe of instruments creates order fragmentation despite the fact that many of these assets share similar investor profiles from a risk-return perspective. Using crossing algorithms, the software can intelligently increase the available liquidity and hence the propensity for clients to trade, by grouping together orders of similar instruments based on the knowledge of the market place and the reasons for which clients are choosing to enter into these positions.

This allows the software to uniquely identify execution opportunities where conventional systems that rely on two orders to be an exact instrument match cannot. For example, the software recognizes that a client seeking to purchase £5 m of the HSBC 4.875% 15JAN14 bond may be willing to purchase £5 m of HSBC 4.5% 30APR14 or possibly £5 m BACR 5.25% 27MAY14 instead, if these are available and the client directed to them.

Furthermore, the invention reduces the amount of information exchanged between traders who wish to trade a particular instrument. By minimising the amount of information presented to the traders less information leakage can occur.

No details relating to the matched order or the associated client are revealed to protect their anonymity, and the only information clients have when deciding to initiate a negotiation from an execution opportunity for one of their orders, includes the crossing score representing the propensity to trade along with the crossing algorithm that generated it. Throughout the negotiation process the software restricts information flow between the two clients based on a principle of only revealing the minimum required detail at the latest possible stage; a client's identity, order price and quantity are never disclosed to the opposite party. The software preserves quantity anonymity by allowing the CA to intervene when quantities differ between the clients' orders to cover the long or short position as appropriate. This comes with the added benefit of increasing the propensity to trade for orders that cannot be traded on a partial basis. Anonymity is maintained even after a successful execution, with all executed trades booked against the CA.

A completely customizable pricing model is used for processing the target prices supplied by both parties to calculate bid and offer execution prices that incorporate any markup the CA wishes to earn across the buyer and seller legs. While clients do not require trading relationships between themselves, they must each establish a trading relationship with the CA in order to trade, and those institutions with an already established client base will be better suited to building up an order universe.

The above anonymity is particularly relevant to those clients looking to take on large or illiquid positions, and are concerned about information leakage impacting market prices. It is therefore important that the CA puts into place practices that protect their clients' anonymity, and maintains their trust to ensure continued liquidity into the order universe.

According to an aspect of the invention there is provided apparatus and methods as set out in the claims. There is provided A computer implemented method to anonymise transactions conducted via a trading platform between a clearing agent in communication with a trading database, and a client terminal, the method comprising: identifying the client terminal with an anonymised client identifier; the clearing agent receiving from a client terminal, as an order, a request to buy or sell a quantity of financial instrument and assigning an anonymised order identifier to the request; for each anonymised order identifier the trading database identifying identical or similar financial instruments, and their quantity, offered by a plurality of other users for the financial instrument in the request and assigning a weighted score of the likelihood of a match between the identified instruments and the requested instrument; presenting on the client terminal, as a trade offer anonymised information of the weighted score of the likelihood of a match between the requested and each of a plurality of identified financial instruments; and indicating via the client terminal if one or more of the trade offers is to be negotiated or accepted.

Optionally, there is a software platform that establishes a liquidity pool for a clearing agent (CA) whose clients can anonymously contribute orders for a financial instrument for which the system adds differentiating value by intelligently identifying execution opportunities via two unique features: (i) an order crossing process where for each order, crossing algorithms are applied that operate without the conventional restriction that instruments must be identical, to instead identify execution opportunities by intelligently matching against comparable instruments and generating quantitative scores of their propensity to trade; and (ii) an order negotiation process that aims to streamline the workflow from initiation through to execution while always protecting counterparty anonymity along with limiting price and quantity discovery, based on a model of revealing the minimum information required at the latest possible point in the lifecycle for a significant reduction in the cost of information leakage associated with conventional markets.

Optionally where the asset class of the financial instrument can represent a stock, a bond, a commodity, a currency, an equity, a derivative security, or a future, and where all orders in the liquidity pool for instruments with the same asset class collectively represent an order universe, and/or, where an order is comprised of a number of parameters that represent a client's interest to buy or sell a specified quantity of a financial instrument and/or where clients can contribute liquidity on a single or bulk order basis and/or where the order universe is kept anonymous such that clients can only see their orders. Preferably where crossing algorithms are used to generate bidirectional scores between two orders that provide a quantitative evaluation of their propensity to trade, with each designed specific to the instrument asset class in question, and customized based on but not limited to the following: (a) comparison of any instrument static parameters (e.g. seniority, currency), (b) comparison of any instrument analytics parameters (e.g. duration), and (c) comparison of any order parameters (e.g. quantity). Preferably where the order universe is monitored and for each order, an exhaustive comparison is performed against all other orders to generate quantitative scores, across all the order universe's associated crossing algorithms, to maintain an associated crossing result that consists of corresponding orders with non-zero scores, grouped by crossing algorithm. Optionally, where the monitoring of the order universe occurs in real-time and involves identifying any state changes that may impact the crossing result for one or more orders, to ensure crossing results are appropriately updated to reflect these changes, the triggering of which includes but is not limited to: the addition of new orders into the universe, changes to order, instrument static, analytics or negotiation state data. Optionally, where crossing results allow clients to find execution opportunities against other relevant orders in the order universe by identifying the highest scoring match across all crossing algorithms as well as on a per crossing algorithm basis. Optionally, where crossing results maintain anonymity by: (a) not revealing the depth of the crossing results in terms of number of non-zero scoring matching orders and instead identifying the highest scoring order per crossing algorithm,

(b) not revealing the client against whose order a match has been found, and (c) not revealing the instrument for which a matching order has been found. Optionally, where order negotiation is split across three phases: (a) Initiation, (b) Negotiation and (c) Execution Optionally, where a negotiation between two orders can be initiated either: (a) from the highest scoring match across all crossing algorithms of a crossing result associated with one of the orders, (b) from the highest scoring match for a given crossing algorithm of a crossing result associated with one of the orders, or (c) automatically by the platform on behalf of the initiator immediately following a failed negotiation. Optionally, where a client's identity is never revealed to the other party at any point during the negotiation phases. Optionally, where the instrument being negotiated on is driven from the seller's order and is only revealed to the buyer upon the buyer receiving either: (a) a request to enter a negotiation initiated by the seller, or (b) intent to enter a negotiation from a seller following an initiation by the buyer. Optionally, where both parties must supply target execution levels before the negotiation can complete. Optionally, which involves applying a pricing model during negotiation to calculate achievable bid and offer execution levels based on the requirements of the CA, which may also include ensuring the CA earns any required markup. Optionally, where either party of a negotiation is able to pass at any point during the negotiation phases up until they make a firm commitment to execute at an agreed level. Optionally, where if the buy and sell quantities do not match the platform allows the CA to inject additional liquidity to cover the remaining short or long position, either against an internal trading account or that of an external counterparty, by supplying a firm price for this position. Optionally, where on successful completion of a negotiation the platform creates two trade legs: (a) a leg to reflect the CA selling the instrument to the buyer at their accepted bid execution level for the quantity they specified on entering the negotiation, and (b) a leg to reflect the CA buying the instrument from the seller at their accepted offer execution level for the quantity they specified on entering the negotiation. Optionally, where if for the successfully completed negotiation the buyer quantity is greater than the seller quantity, the platform creates a third leg to reflect the CA buying the instrument at the firm price specified during Phase 2 for the quantity that covers the difference between the buyer and seller legs. Optionally, where if for the successfully completed negotiation the buyer quantity is less than the seller quantity, the platform creates a third leg to reflect the CA selling the instrument at the firm price specified during Phase 2 for the quantity that covers the difference between the buyer and seller legs. Optionally, for which its users can interact via the coupled user interface or the electronic API gateways that act as a bridge through which external systems communicate with the platform, where interaction includes but is not limited to: submission of orders, managing of orders, reviewing crossing results, initiating negotiations, managing the negotiation lifecycle and reviewing executed trades. Optionally, which provides an electronic API through which the CA can contribute external instrument analytics services, static data feeds and price feeds to the platform. Optionally, which provides an electronic API through which the CA can integrate its systems in order to receive notification of executed trade legs from the platform. Optionally, which provides an electronic API through which the CA can integrate its own notification mechanisms for direct access by the platform, support for which includes but is not limited to: SMS, email, instant messaging and social networking distribution channels.

### BRIEF DESCRIPTION OF THE FIGURES

Embodiments of the invention are now described, by way of example only, with reference to the accompanying drawing in which:

FIG. 1 illustrates an overview of the invention, a multi-featured platform;

FIG. 2 illustrates a more detailed system diagram;

FIG. 3 illustrates a diagram that provides an example order universe where three clients have uploaded a total of nine orders;

FIG. 4 shows an interface that provides a user with an Order Entry form to upload single order entries into the system;

FIG. 5 shows an interface that provides a user with an Order Entry form to upload a bulk order of many entries into the system;

FIG. 6 shows an interface that provides the user with an Order Blotter, listing all active buy/sell orders together with filled, expired and cancelled orders;

FIG. 7 displays a table showing crossing results of example used to explain order matching;

FIG. 8 shows an interface that provides the user with a graphical representation of the crossing order match via a Trade Wheel;

FIG. 9 shows an interface that provides the user with negotiation dialogue boxes allowing them to enter bid/offer prices for a particular order;

FIG. 10 illustrates the pricing model used to calculate the prices for the negotiation of orders;

FIG. 11 illustrates the formula used to calculate the weighted seller price the pricing model takes into account;

FIG. 12 illustrates the formula used to calculate the weighted buyer price the pricing model takes into account;

FIG. 13 illustrates the formula for the Mid Price the pricing model takes into account;

FIG. 14 shows an interface that provides the user with a negotiation panel to monitor and confirm/pass active negotiations together with record keeping of past negotiation outcomes on a particular order;

FIG. 15 shows a table that provides an example of a scenario (scenario 1) of a negotiation where the orders that have matched have the same quantity, and the buyer initiates the negotiation;

FIG. 16 illustrates a diagram that provides an example order universe where two orders have matched with the same quantity;

FIG. 17 shows a flow diagram of an example negotiation scenario described in FIG. 14;

FIG. 18 shows a table that provides an example of a scenario of a negotiation where the orders that have matched have the same quantity, and the seller initiates the negotiation;

FIG. 19 shows a table that provides an example of a scenario of a negotiation where the orders that have matched don't have the same quantities and the seller initiates the negotiation;

FIG. 20 illustrates a diagram that provides an example order universe where two orders have matched with different quantities;

FIG. 21 shows a table that provides an example of a scenario of a negotiation where the orders that have matched don't have the same quantities and the buyer initiates the negotiation.

FIG. 22 shows an interface that provides the user with a Trade Blotter listing all completed trades and details assisting with record keeping;

FIG. 23 shows an interface that provides the clearing agent hosting the platform with a Trade Blotter listing all completed trades and profit made on completed trades;

FIG. 24 shows the full user interface for a client view of the platform, containing Order Entry, Order Blotter, Trade Wheel, Negotiation Panel and Trade Blotter;

FIG. 25 shows the full user interface for a Super User view that the clearing agent will have, containing Order Entry, Order Blotter, Trade Wheel, Negotiation Panel and Trade Blotter (displaying profit); and

FIG. 26 is a data flow diagram of the process of a user executing an anonymised trade.

### DETAILED DESCRIPTION OF THE INVENTION

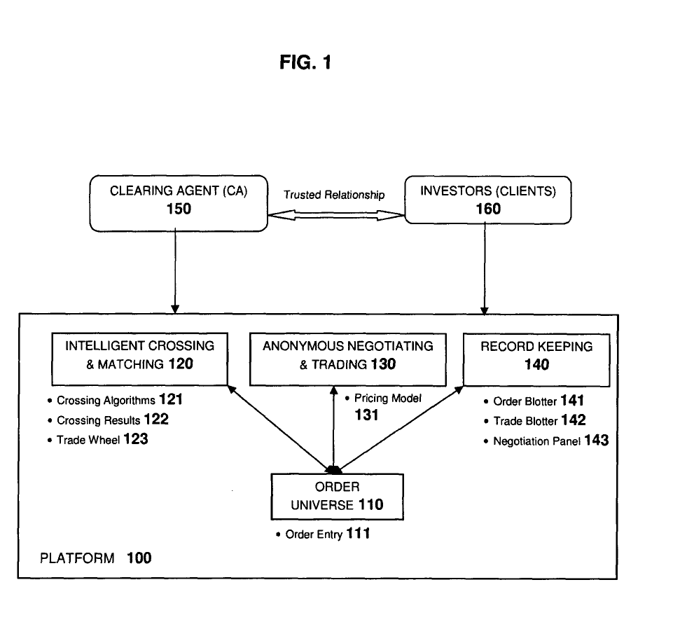

FIG. 1 illustrates an overview of the invention according to an aspect of the invention. There is shown a computer-based method and system comprised of multiple processes, web services and web applications, with each component responsible for a specific scope of functionality. The terms software, application, system and platform will be used interchangeably to refer to the complete solution represented by this invention.

There is shown: the order platform 100 via which trades are conducted; the platform comprising an order universe 110; an intelligent crossing and matching module 120 having crossing algorithms 121, crossing results 122 and trade wheel 123; a anonymous negotiating and trading nodule 130 having a pricing model 131 and a record model 140 having an order blotter 141, trade blotter 142 and negotiation panel 143. The platform 100 in communication with a clearing agent 150 and a plurality of investors (clients) 160. The investors 160 have a trusted relationship with the clearing agent 150 and are in communication with the clearing agent 150 and platform 100. For clarity only one investor 160 is shown.

The order universe 110 is defined all instruments available for trade which have the same asset class. The order universe 110 is not limited to all instances of identical instruments but encompasses instances of similar instruments (in the same class and/or with similar characteristics) available for trade.

The platform 100 provides intelligent order matching 120 of orders uploaded into the order universe 110, and allows clients 160 to anonymously negotiate and trade 130 these orders. The platform is not restrained by existing conventions that orders must be of the same quantity or exact same match in order for a negotiation to occur. Records 140 of all orders and trades are preserved within the platform on a form of writeable memory (not shown).

One business implementation is for a financial institution or broker 150 to host the platform 100 and clients 160 of that organization hosting the platform will have access to the unique liquidity pool that has been uploaded into the system. The hosting party will act as Clearing Agent (CA) 150 to all trades that complete in the application and will be able to make profit on all trades that complete between clients by way of a price mark up on trades. There must be a trusted relationship between CA 150 and its clients 160 to ensure fair trading. In an example, clients assign permission to outside sales agents (not shown) to negotiate and complete trades on their behalf.

Separate user interfaces have been designed for each user role supported by the application, all of which interact with the same order universe 110. For the purpose of this detailed description of the application the user interfaces used as examples have been customized to reflect a bond order universe, but it should be noted that the user interfaces can be tailored to appropriately reflect the characteristics of any other financial instrument class. The user interface is optional and although it provides an “out-of-the-box” means to interact with the platform the CA 150 can also use direct API (Application Programming Interface) to integrate and host the platform 100 via gateway adapters.

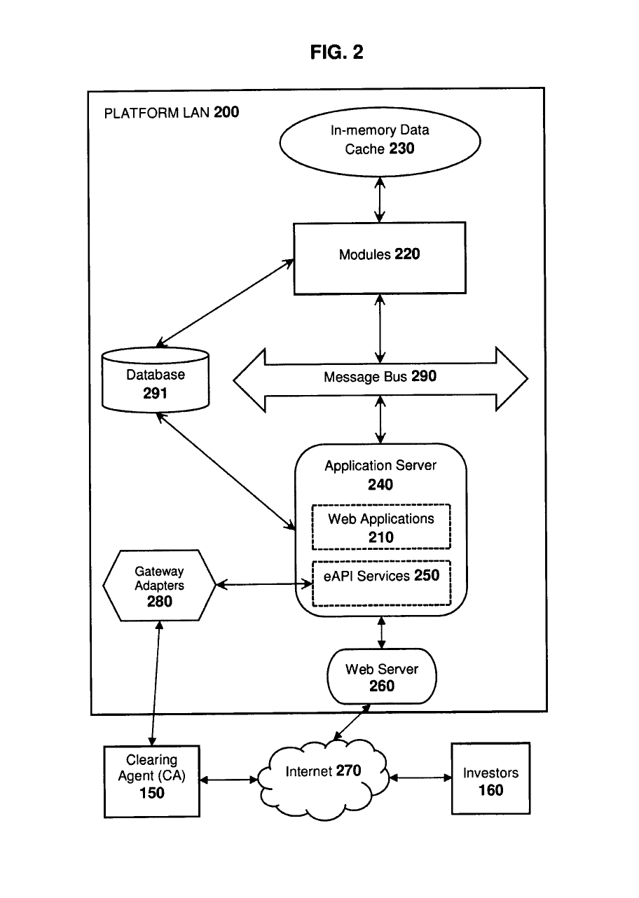

FIG. 2 illustrates a more detailed system diagram in accordance with the invention. The platform LAN 200 represents one or more servers connected via a local area network that together host all the processes and technologies required to run an instance of the invention. The system software is largely split between web applications 210 that are tasked with the rendering of data to be presented via user interfaces to end users, and modules 220 that manage all other business logic along with managing and maintaining the system's state with the help of an in-memory data cache solution 230. The web applications 210 run within an application server 240 alongside a number of services that make up the platform's electronic APIs 250.

Access to the web applications 210 is controlled via a web server 260 that manages bidirectional communication to the application server from the Internet 270 that will originate from both investors 160 and the clearing agent (CA) 150. Access to the eAPI services 250 is only granted to the CA 150 who may do so either by communicating through the Internet 270 via the web server 260, or using bespoke communication protocols via the relevant gateway adapters 280 that in turn transform the communications as appropriate for the eAPI services 250.

Communication between modules 220 and the application server is managed by a message bus 290, and a database 291 is used to keep a permanent record keeping 140 store of all transactions between investors 160 and the CA 150 on the platform 100, along with all reference data. It should be noted that the invention is not dependent on specific vendor implementations for the various technologies incorporated and it is expected that more than one deployment of the platform LAN 200 to exist in a production environment for failover and high availability purposes.

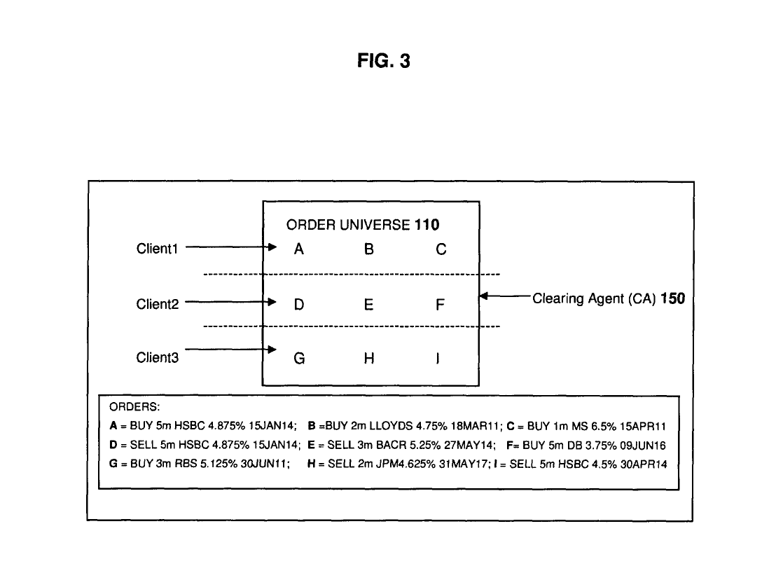

FIG. 3 illustrates an example of an order universe 110 made up of nine bonds. This example will be referred to throughout the detailed description of the invention for all examples of how the application works. In this example, three clients 1, 2, 3 have uploaded three separate orders each; and are only able to access the orders they have uploaded. The hosting organization will act as Clearing Agent (CA) 150 and all trades that execute will complete via the CA. In FIG. 3 the bonds are as follows A=BUY 5 m HSBC 4.875% 15JAN14; B=BUY 2 m LLOYDS 4.75% 18MAR11; C=BUY 1 m MS 6.5% 15APR11; D=SELL 5 m HSBC 4.875% 15JAN14; E=SELL 3 m BACR 5.25% 27MAY14; F=BUY 5 m DB 3.75% 09JUN16; G=BUY 3 m RBS 5.125% 30JUN11; H=SELL 2 m JPM4.625% 31MAY17; I=SELL 5 m HSBC 4.5% 30APR14.

All the instruments in the order universe 110 are similar products and share the same sector: Financials. In other examples the order universe 110 can be increased or decreased in size by varying the definition of what products are included within a universe 110.

An aspect of the invention is that the software has access to a pool of orders that represent the liquidity driving the platform; this liquidity is referred to as the order universe 110. The order universe is built up by clients 160 who can submit their orders on a bulk or individual basis, where an order is comprised of a number of parameters that represent a client's interest to buy or sell a specified quantity of a financial instrument. In the example shown client 1 has indicated that they are trading bonds A, B and C, client 2 bonds D, E and F and client 3 bonds G, H and I.

All orders in a universe must be for instruments belonging to the same asset class, although it is possible for the platform 100 to support multiple asset classes by maintaining an order universe for each one.

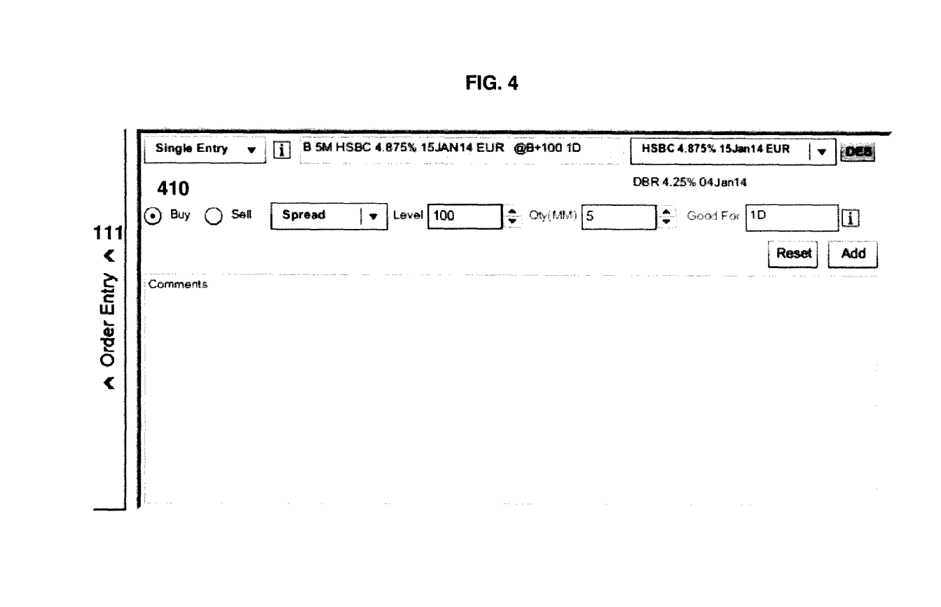

FIG. 4 shows a screenshot of an example order entry interface 111 that is presented to a client 160 and allows the client 160 to allow single entry 410 to add liquidity to the order universe 110. There is shown the “speed bar” 420 and template field interface. The order entry interface 111 is presented to the client 160 via a known interface on a computing device (for example, desktop computer, smartphone, laptop computer etc.). The user interacts with the interface 111 via standard input devices e.g. keyboard, touchscreen etc.

The user is able to either enter full details of a buy or sell order in the “speed bar” 420 or use the template fields to complete necessary criteria to the order such as quantity and spread/clean price. They can also specify how long the order is to remain active in the order universe. The user will then press “Add” button to upload the order into the system.

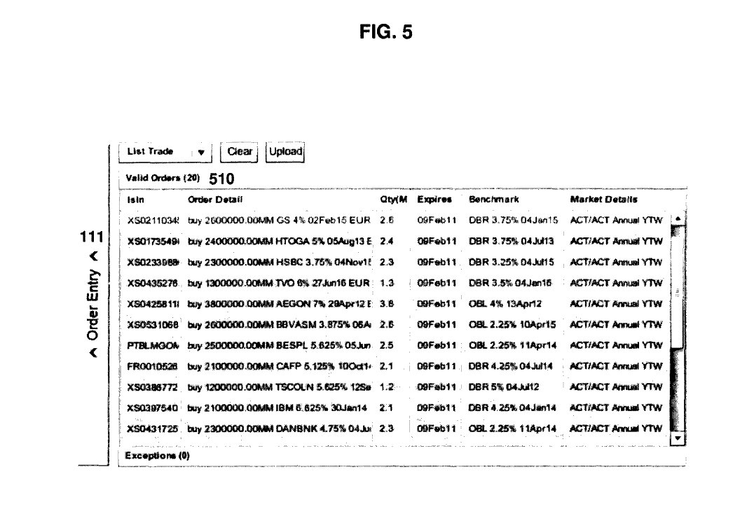

FIG. 5 shows the order entry interface 111 for a list trade 510, which provides the user with the ability to upload a bulk list of orders in one go by pasting the information into the form and pressing “Upload”. Preferably, the template of the information required for the bulk upload is agreed between CA and user before the list trade 510 form can be used to ensure mandatory information of the order is provided. This ensures consistency in the information presented reducing the amount of processing required to This feature advantageously allows users to upload an entire portfolio of financial instruments in one go.

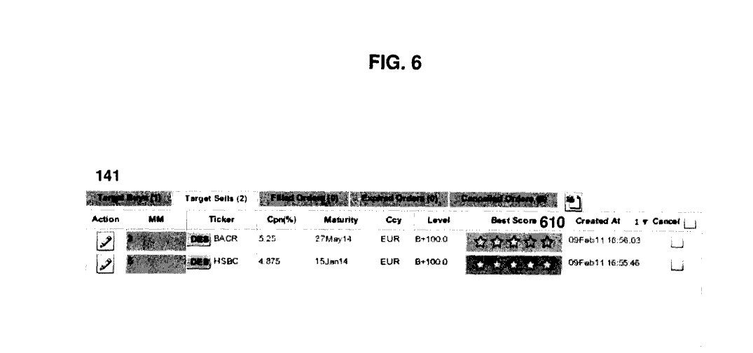

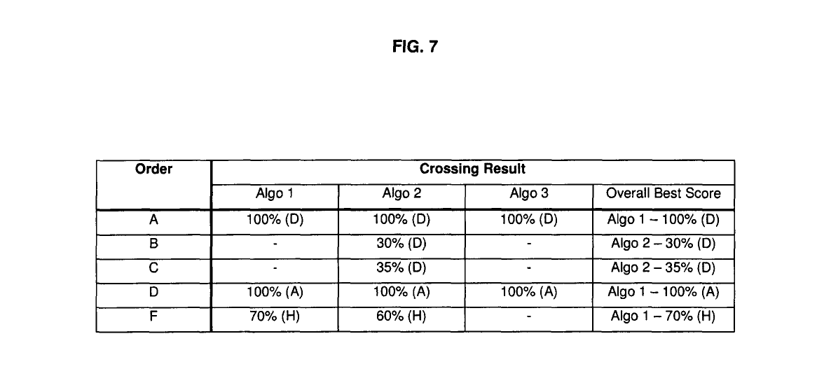

FIG. 6 shows the interface for the Order Blotter 141 that allows users to see all orders they have uploaded onto the platform 100. The record keeping 140 of the orders in the platform 100 is done real time, with a time stamp applied to each order uploaded into the system or as it is modified. The Order Blotter displays buy and sell orders for each user, together with a list of any orders that have been filled, expired or been cancelled. FIG. 6 specifically displays orders based on the order universe 110 described in above example FIG. 3 where Client 2 has uploaded two sell orders and one buy order onto the platform 100. These active orders have been crossed and matched against other orders in the universe and the best score 610 for each order is provided to Client 2 showing their propensity to trade against another order in the universe (although Client 2 will not be aware of what the other orders in the universe are). The “Best Score” 610 column displays which algorithm has been used to match the order via colour coding, together with a star rating showing the strength of the order match. The process of the calculation of the cross matching score is described in further detail below.

Order Matching 120 is the functional area within the application that addresses the issue of liquidity fragmentation created in markets where client orders are made across a large collection of unique instruments. The aim of crossing orders is to increase the liquidity available to clients by intelligently identifying and presenting related liquidity to the application users. To achieve this requires the following:
Access to all active orders within the order universe
Access to all instrument static/analytics required to cover the instrument universe representing the active orders
Access to the complete negotiation history (including on-going negotiations) for all active orders
Notification of changes to order, instrument static/analytics and negotiation state
One or more crossing algorithm to be associated with the order universe for each supported instrument asset class

Crossing Algorithms 121 are used to generate bidirectional scores between two orders that provide a quantitative evaluation of their propensity to trade. These algorithms are designed specific to the instrument asset class in question and can be customised based on (but not limited to) the following:
Comparison of any instrument static parameters (e.g. seniority, currency)
Comparison of any instrument analytics parameters (e.g. duration)
Comparison of any order parameters (e.g. quantity)

The algorithm crossing scores range from 0-100, where 0 represents an order pair with no possibility of trading and 100 representing the highest propensity to trade. Depending on the nature of the crossing algorithm used it is possible for asymmetry when generating scores; thus two scores are calculated per order pair to allow bidirectional evaluation of propensity to trade. Crossing algorithms preferably obey the following conditions:
If a score of zero is generated in one direction, the inverse score must also be zero
Order pairs that belong to the same client must generate zero scores
Order pairs for the same transactional direction (buy/sell) must generate zero scores
Order pairs that have already been negotiated on and have not been modified since must generate zero scores
Order pairs that include at least one inactive order must generate zero scores

Examples of three crossing algorithms for the bond financial instrument asset class have been defined below; these have been simplified for clarity and do not represent complete real-world solutions but are suitable for illustrative purposes:
Algorithm 1—Same Sector, Maturity within 1 year
Only bonds that share the same sector and have maturities within a year of each other will generate a non-zero score
A higher score rating is proportional to the proximity of the two maturities
Algorithm 2—Same Sector, Maturity within 3 year
Only bonds that share the same sector and have maturities within three years of each other will generate a non-zero score
A higher score rating is proportional to the proximity of the two maturities
Algorithm 3—Same Ticker, Maturity within 1 year
Only bonds that share the same issuer ticker and have maturities within a year of each other will generate a non-zero score
A higher score rating is proportional to the proximity of the two maturities

In order for Crossing Results 122 to be calculated the order universe 110 is monitored on a real time basis, and for each order an exhaustive comparison is performed against all other orders to generate bidirectional scores, across all the order universe's associated crossing algorithms. This process generates a crossing result 122 for each order that consists of corresponding orders with non-zero scores, grouped by crossing algorithm, where:
For each crossing algorithm:
   The highest scoring order is identified
   The average order crossing score is calculated
   An algorithm score is calculated based on the number of (non-zero) crossings, best score and average score
The overall highest scoring order is identified along with the algorithm that generated it

In an example the crossing algorithm is calculated by considering the number of parameters between the requested financial instrument and that offered. For example in order to achieve a non-zero score, in an embodiment, the security type, current and whether the bond is a floater or not must match.

The following is an example of the various parameters used to consider when two instruments are considered to match. In further embodiments depending on the sophistication of the match more (or indeed fewer) parameters may be considered.

First the “Order Parameters Eligibility Criteria” is assessed. With both buyer and seller being in active and the instrument having different owners. If the eligibility criteria is not met a score of “0” is assigned as the instruments are not suitable for trading with each other.

Them the “Bond Static Parameters Eligibility Criteria” is considered. Here parameters such as the instruments being in the same sector, being a floater or not, currency, seniority and security type are considered. Instruments which have the same parameters will score higher than those which do not. Other factors include if the instrument is within max. S&P rating deviation of 3 notches; max Fitch rating deviation of 3 notches; or max Moodys rating deviation of 3 notches.

Then “Bond Analytics Parameters Eligibility Criteria” is considered with the maximum deviation of being set as 40% of smallest duration value.

A further parameter is the “Order Parameters Scoring Behaviour” which assess the Quantity Score.
1 if quantity2 >=quantity1
Otherwise:

1. minQuantityScore=0.65

2. Quantity score=Quantity2/quantity1*(1−minQuantityScore)+minQuantityScore

A further consideration is the “Bond Static Parameters Scoring Behaviour” which determines a rating score based on the ratings given by credit agencies. In an embodiment the “Rating Score” is a composite score across all rating types with final score as:

a. S&PScore * FitchScore * MoodysScore

Individual rating scores are calculated so that for every rating deviation of 1 notch reduce, score by 20%:

a. 0.8̂ notch deviations

There is also a waiting according to “Issuer Score” set as:

1 if issuer names are identical

Otherwise 0.75

Yet another consideration is the Duration Score, which considers the “Bond Analytics Parameters Scoring Behaviour” where is calculated using the minimum value of:

a. Duration1/Duration2

b. Duration2/Duration1

Once each parameter has been calculated for two financial instruments the “Complete Scoring Behaviour” giving the final Crossing Score is given as:

0 if eligibility criteria not met

((DurationScore*0.6)+(RatingScore×0.4)) * QuantityScore * IssuerScore * 100

This gives a score which provides a weighting indicative of the likelihood of a match between two products.

Based on the order universe portrayed in FIG. 3 and the three crossing algorithms defined above, FIG. 7 displays a table of an example of the best score summary of some crossing results that may be generated. To help demonstrate how this process works, the order that has generated the score for each algorithm is shown in parenthesis but this information would not be available to clients viewing the crossing results for their order.

An analysis of the crossing result data in FIG. 7 is summarised below (based on orders listed in FIG. 3):
For order A the overall best score has been derived from Algorithm 1 which has calculated that order D is a 100% match, as expected given that orders A and D are for the same bond.
For order B negotiation opportunities are only available based on Algorithm 2, with a score of 30% against order D suggesting the corresponding order is not a particularly strong match.
For order C negotiation opportunities are only available based on Algorithm 2 with a score of 35% against order D suggesting the corresponding order is not a particularly strong match. As expected the score is more promising than the crossing result for order B given the maturity of order I bond is closer to that of order I.
As expected given orders A and D are for the same bond we see a symmetrical score for order D compared to the crossing result of order A.
The crossing result for order F shows Algorithm 1 has generated the highest score although a similarly scored opportunity is also available via Algorithm 2.

This breakdown of the crossing result 122 allows clients to select an order to negotiate with based on either the best overall score or best score for a given algorithm, if the scores are perceived to represent acceptable indicators of propensity to trade. In the example based on FIG. 7 and FIG. 3 for order F, Client 2 can choose to negotiate against the match presented from the best overall score (70%) or that of Algorithm 2 (60%). For this example both options correspond to order H but this is not known by Client 2 as this detail is not available to them. This flexibility is driven by the understanding that clients may feel that a lower score generated by an alternative algorithm might yield an instrument more appealing from an execution perspective if the algorithm's scoring characteristics focus on more relevant criteria.

The platform 100 maintains an up-to-date crossing result for each order, and on notification of any state changes to an order, instrument static/analytics or negotiation data, all impacted orders will be identified. A time window is configured during which a list of impacted orders is built, and once the time window has elapsed new crossing scores are calculated for all orders in this list across all crossing algorithms. The length of the time window controls the maximum delay before crossing results reflect the changes, with a value of 0 seconds meaning advantageously crossing results 122 are updated in real-time.

As the platform maintains an up-to-date crossing result for each order, it allows clients to find the best available matching order (identifiable only as a crossing score) and direct them to a negotiation/trade opportunity. Thus order crossing is able to achieve the following:
1. Identify additional liquidity over conventional markets that only allow crossing orders when the trade instruments are identical.
2. Annotation of this additional liquidity with a quantitative means of assessing its quality with regards to the propensity for two matched orders to trade.
3. Keep the details of the order universe anonymous from clients:
   The size of the order universe cannot be determined as no indication of the number of crossed orders is given.
   No detail of the best matched order is given to clients—only the score and algorithms used are revealed, with additional details only made available during the negotiation process.

Thus the platform 100 allows for additional trades to be conducted because in the prior art the user would only be able to trade in identical instruments. The calculation and presentation of the crossing score allows users to rapidly and efficiently identify other instruments that they would not have normally considered (as they are not identical to the desired product). Furthermore, the clients 160 are presented with a minimum of information reducing information leakage from the order universe 110.

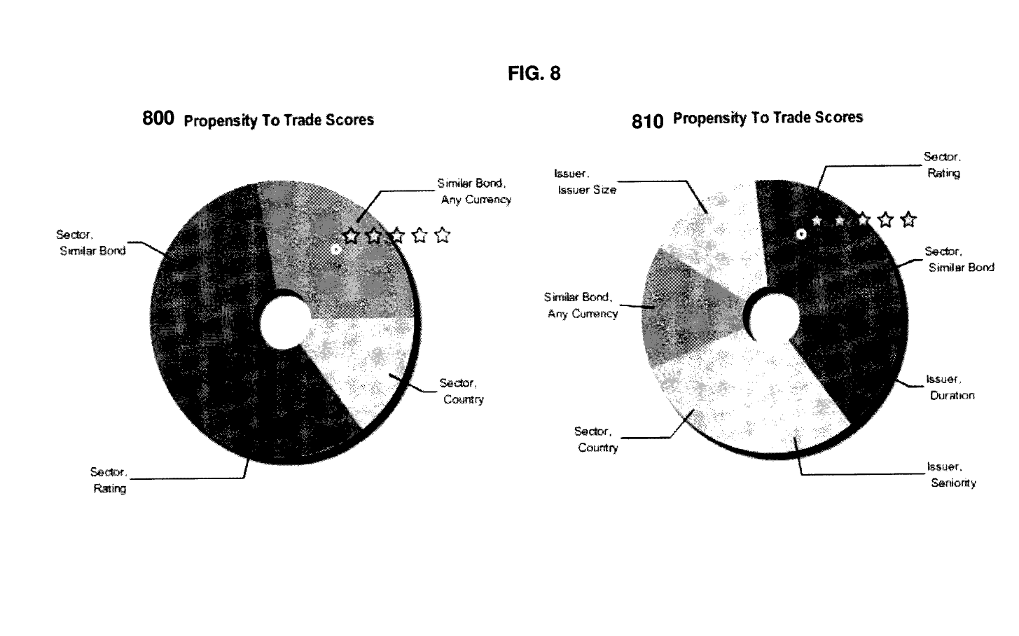

The user interface also provides a unique graphical representation to present the scores of the overall best score and crossing algorithms that make the score, known as the Trade Wheel 123 in a qualitative manner (see FIG. 8). The weighting of each pie segment in the Trade Wheel is driven by each algorithm score, and the highest order score for that algorithm is represented by a 0-5 star rating also displayed in the Order Blotter 141. The Trade Wheel uses colour coding as a means of defining the pie segments and this colour code is applied for each crossing algorithm and is displayed throughout the order lifecycle where orders match for that particular algorithm. FIG. 8 shows two Trade Wheels, the first 800 is the matching score of order E that Client 2 has uploaded into the order universe 110 as defined in FIG. 3. This informs Client 2 that the order has matched with 4 algorithms and provides a star rating of three to show the strength of overall best score. The second Trade Wheel 810 is for order D that Client 2 has uploaded, showing that it has matched seven algorithms and has a stronger star rating of five.

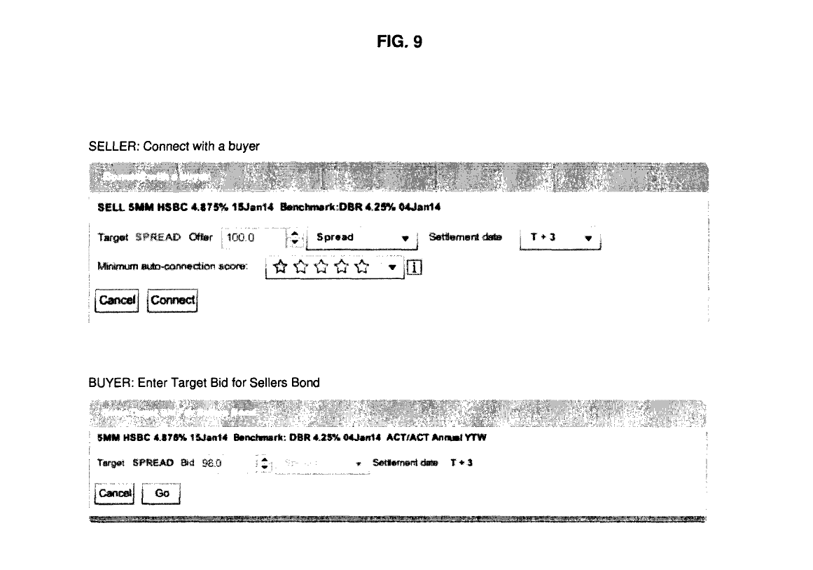

Clients can choose to initiate a negotiation on their order by double clicking a row in the Best Score 610 column in the Order Blotter 141 or from the highest score for a specific crossing algorithm by double clicking a pie segment of the Trade Wheel 123 (see FIG. 8). Dialogue boxes are presented to both parties in the negotiation once a negotiation has been initiated allowing them to negotiate anonymously with each other (see FIG. 9). They are able to suggest a target big/offer spread/clean price to trade the financial instrument.

Searching for execution opportunities drives the motivation to place liquidity into the order universe to be processed for crossing. Once a client has found a relevant execution opportunity as represented by a match against an order with an acceptable crossing score, they are able to initiate a negotiation request. Order negotiation 130 is the unique process by which the software manages a three phase lifecycle from initiation through to execution.

Phase 1—Initiation
A negotiation can only be negotiated for an order from an opportunity highlighted in its crossing result, and will be against an order with the highest score either:
   Across all crossing algorithms; or
   For a specific crossing algorithm that best considers the instrument and order criteria relevant to the client.
The initiator can cancel the negotiation at any point during this phase.
The instrument being negotiated on is always based on that specified by the seller's order.
   This is to reflect that the seller is already long the instrument while the buyer's order is viewed as a firm indication to purchase an instrument with a similar investor profile (where similar is more completely defined by the crossing algorithms in use) to that specified in the order.
The only information available to the initiator about the crossed order is its crossing score (along with the inverse score) for the crossing algorithm used to initiate the negotiation.
Clients can request to negotiate on behalf of either a buy or sell order where:
   Sellers must specify a target price before they can initiate a negotiation request;
   Buyers cannot specify a target price as the negotiation instrument has not yet been revealed to them;
   Sellers that initiate a negotiation do so understanding that the instrument specified in their order will be revealed to the buyer on receiving the request.
When sellers initiate the target price is preset to the level specified in their order although it can be changed.
On initiation of a new negotiation the responder is alerted and has a system-controlled time window in which to respond.
If initiated by a buyer, the responder (seller) bases their decision to proceed based on the crossing score and the algorithm used.
If initiated by a seller, the responder (buyer) bases their decision to proceed based on the seller's instrument along with a proposed bid price.
   The proposed bid price is calculated by the software such that it can be guaranteed if the negotiation is successfully executed.
If the responder is not interested they can either:
   Immediately inform the initiator by passing; or
   Ignore the request and wait for the time window to elapse at which point the system informs the initiator that the negotiation request timed out.
If interested, the responder must submit a target price for the negotiation instrument in order to proceed to Phase 2.
   Responding buyers do not have to accept the proposed bid and are able to input a different target bid.
   Responding buyers are also able to adjust the amount they want to purchase of the now revealed negotiation instrument.

Phase 2—Negotiation
Either party can choose to pass and cancel the negotiation at any point during this phase.
For negotiations initiated from a buy order the buyer:
   Can now see the negotiation instrument is that specified in the seller's order;
   Is presented with a system calculated proposed bid;
   Is prompted to submit a target price of their choosing;
   Can adjust the amount they want to purchase of the now revealed negotiation instrument;
   Has a system-controlled time window in which to respond before the negotiation is timed out.
Where the buy and sell quantities do not match intervention is required by the CA to supply a firm price to cover the remaining short or long position as appropriate.
   The CA must specify if the position is to be taken against an internal CA trading account or that of an external counterparty.
   If the buyer quantity is greater than the seller quantity the CA will be required to take an additional short position with the buyer to cover the difference.
   If the buyer quantity is less than the seller quantity the CA will be required to take an additional long position with the seller to cover the difference.
   The CA has a system-controlled time window in which to respond before the negotiation is timed out.
   The CA is able to pass if they cannot cover the position and doing so will terminate the negotiation.
   Once the CA has supplied a firm level they are unable to pull the level or terminate the negotiation.
Counterparties are not aware if their order is being met solely by the other or whether the CA has intervened, and if the CA terminates the negotiation both parties are informed that the other party passed so as not to reveal the CA's involvement.
Once both parties have supplied their target prices and, if required, the CA has provided a firm level to cover any outstanding position, the lifecycle proceeds to Phase 3.

Phase 3—Execution
Using the available target levels for all positions the system applies a pricing model to calculate bid and offer execution levels.
   These are presented to the buyer and seller respectively.
   The buyer and seller have a system-controlled time window in which both must respond before the negotiation is timed out.
Both parties can cancel the negotiation by passing if they are not happy with the proposed execution level.
Once a party accepts their execution level it is taken to be a firm commitment to execute and their ability to pass is removed. p0 A negotiation is successfully executed once both parties accept their execution levels, and results in both the associated buy and sell orders being marked as inactive.
On successful execution of a negotiation where buyer and seller quantities are the same the platform creates two trade legs:
   A leg to reflect the CA selling the instrument to the buyer at their accepted bid execution level for the quantity they specified on entering the negotiation; and
   A leg to reflect the CA buying the instrument from the seller at their accepted offer execution level for the quantity they specified on entering the negotiation.
On successful execution of a negotiation where the buyer quantity is greater than the seller quantity the platform creates a third leg to reflect the CA buying the instrument at the firm price specified during Phase 2 for the quantity that covers the difference between the buyer and seller legs.
   This leg will either be booked against an internal trading account or that of an external counterparty depending on what was specified during Phase 2.
On successful execution of a negotiation where the buyer quantity is less than the seller quantity the platform creates a third leg to reflect the CA selling the instrument at the firm price specified during Phase 2 for the quantity that covers the difference between the buyer and seller legs.
   This leg will either be booked against an internal trading account or that of an external counterparty depending on what was specified during Phase 2.

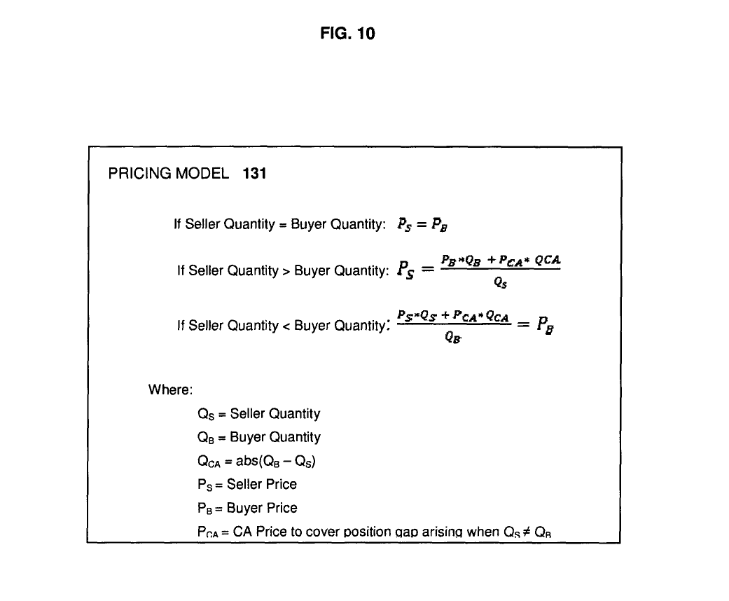

Phase 3 incorporates a pricing model 131 from which execution levels are derived. The software includes a default implementation outlined below but the patent is not limited to this as the order negotiation lifecycle supports changes to this model or even replacing it so as to align with the objectives of the CA. The core principles that the default pricing model is based on are:
1. Buyer Bias—A key premise of the model is to bias in favour of the buyer's target price over that of the seller. This is to reflect that the buyer is not necessarily negotiating to buy the same instrument identified in their order but rather one with similar characteristics. Thus the buyer's price is assumed to already reflect the degree in which the buyer feels the trade is a compromise for their ideal instrument and therefore not be as flexible to negotiate. On the other hand the seller is not having to make this compromise and is assumed to be more willing to be flexible on price in order to make the trade happen.
2. Markup—The pricing model caters for the application of trade markups to allow the CA to preserve a pre-defined edge on an executed negotiation as profit. This is driven on a per instrument basis allowing the CA to customize the markup earned as appropriate based on instrument characteristics. Given Buyer Bias, markup is usually applied in full to the seller price only.
3. Firm Liquidity Cover Prices—Whenever liquidity is provided by the CA to cover positions created by differences between buyer and seller quantities, the supplied trade price is always honoured and used to derive execution bid and offer prices.
4. Preserve Original Target Prices—Derived buyer and seller execution prices will never be better than the target prices originally specified on entering the negotiation, even if this results in the CA earning a markup greater than that associated with the trade instrument.
5. Proposed Buyer Price—It is assumed that on prompting the buyer for a target price, a proposed bid is communicated. This proposed bid is calculated as a markup on top of the seller's target price, and if accepted by the buyer comes with the guarantee that it will be honored should the seller agree to trade.
6. Price Sanity Check—Before derived prices are presented to either party a sanity check is applied to ensure that the calculated prices are within a configurable tolerance of the target prices. This is to prevent input errors or extreme prices from producing inappropriate prices with both parties informed that achievable execution levels could not be found if this check is failed.
7. Execution Prices Must Balance—FIG. 10 shows the core premise of the pricing model 131 and must hold for all pricing scenarios in the absence of markup.

Based on the above principles the default pricing model 131 generates execution levels as follows:

Equal Buyer and Seller Quantities

1. The bid execution level is set to the buyer's target bid.

2. The seller price is calculated using the relevant scenario formula from the principle “Execution Prices Must Balance”.

3. The offer execution level is calculated by applying the relevant instrument markup to the calculated seller price.

Different Buyer and Seller Quantities. Buyer Accepts Proposed Price

1. The bid execution level is set to the buyer's target bid.

2. The CA price is kept fixed at the firm level supplied during Phase 2.

3. The seller price is calculated using the relevant scenario formula from the principle “Execution Prices Must Balance”.

4. The offer execution level is calculated by applying the relevant instrument markup to the calculated seller price.

Different Buyer and Seller Quantities, Buyer Alters Proposed Price

1. The CA price is kept fixed at the firm level supplied during Phase 2.

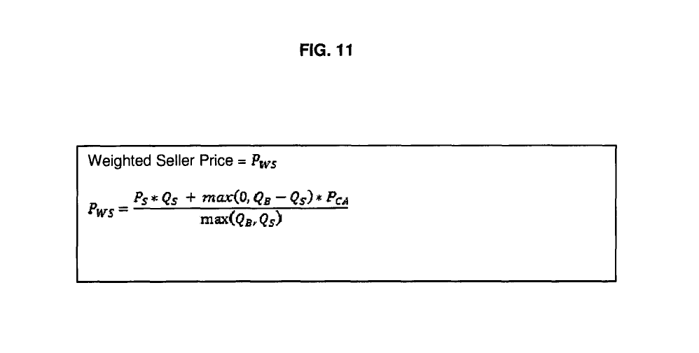

2. A weighted seller price (P_{WS}) is calculated (see FIG. 11)

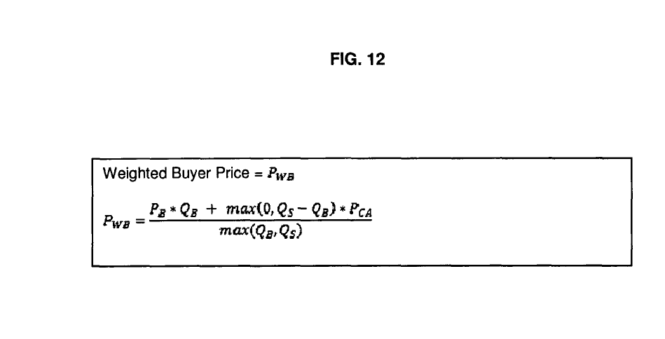

3. A weighted buyer price (P_{WB}) is calculated (see FIG. 12)

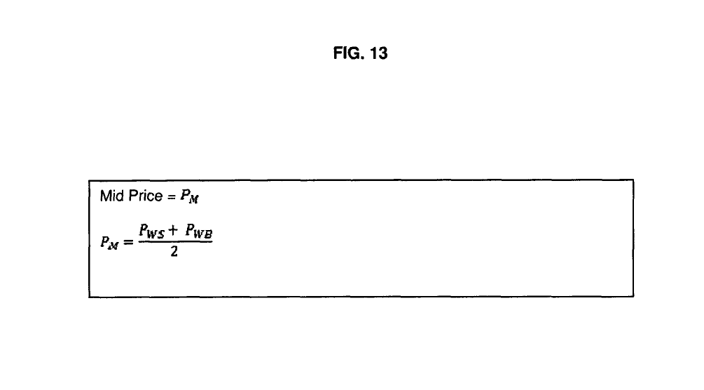

4. A mid price (P_{M}) of the weighted execution prices is calculated (see FIG. 13)

5. The seller price is set to that of the mid price.

6. The bid execution level is calculated using the relevant scenario formula from the principle “Execution Prices Must Balance”.

7. The offer execution level is calculated by applying the relevant instrument markup to the mid-price.

It is also important to outline some additional aspects to the lifecycle described above:

1. Once two orders have been negotiated on, the platform will remove each order from the other's crossing results. This will mean the second highest scoring order in each crossing result (if one exists) will now be promoted and allows orders with failed negotiations to find new execution opportunities. If either of these orders is modified following the negotiation terminating, they will reappear in each other's crossing results in case the changes made have an impact on propensity to trade scores.

2. The negotiation lifecycle can be augmented with an optional auto-initiate feature. When enabled, for all failed negotiations not caused by the initiator passing or failing to respond, the system acts on the initiator's behalf to automatically search for the next best order to negotiate against. This is driven by the crossing result associated with the initiator's order and the system will select the order to initiate against in the same way the initiator did for the failed negotiation, i.e.: best score across all crossing algorithms versus a specified crossing algorithm. Initiators must also specify the minimum score for which they are happy for the system to auto-initiate a negotiation. Auto-initiation will therefore only happen if there is at least one other order with a crossing score higher than the specified minimum threshold.

3. The default behaviour during Phase 2 is to limit both parties to supplying only one target price before moving onto Phase 3 to calculate execution levels. The system can be configured to extend Phase 2 by allowing both parties to submit revisions to their target levels until their levels are within a system-defined proximity before proceeding to Phase 3. Both parties will receive qualitative feedback during Phase 2 indicating that their level requires improvement before achievable execution levels can be found.

4. The platform can be configured to support CAs that do not wish to intervene when buy and sell quantities are mismatched. The behaviour in this configuration is for the negotiation to assume the smaller of the two quantities, and on successful completion the smaller order is closed while the larger is decremented by the trade quantity. While this comes at the advantage of not requiring the CA to cover the liquidity gap, it is at the cost of some information leakage with regards to available liquidity.

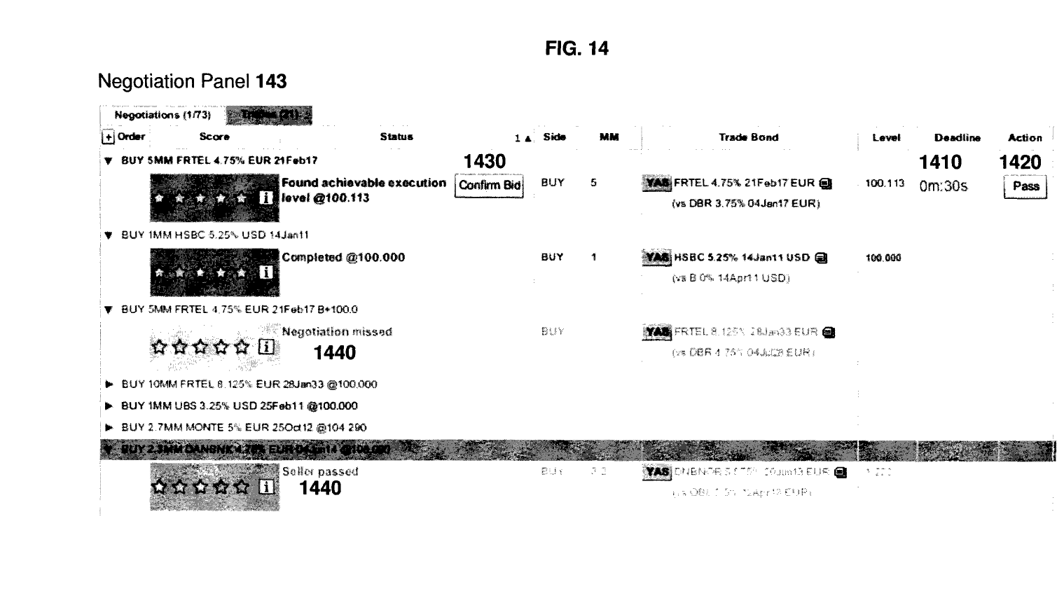

FIG. 14 shows the Negotiation Panel 143 where users are able to monitor and complete active negotiations. Both parties to a negotiation (the buyer and seller) have a real-time counter 1410 displaying the countdown time they have left to make a decision during the negotiation. The time is fixed for each stage of the negotiation lifecycle as described above. Both parties have the opportunity to pass 1420 on a negotiation at any point during the lifecycle. They are also able to confirm 1430 to trade during the negotiation phases once a firm price has been provided to them from the system as described above. The Negotiation Panel 143 also provides a clear and concise record 140 of all previous negotiations 1440 keeping a history of attempted negotiations that were not successful as well as displaying those that have completed successfully on an order.

Given the numerous ways a negotiation may take place and conclude, below are a four scenarios used as examples to help demonstrate order negotiation. For these example scenarios the bond order universe 110 described in FIG. 3 is used along with the sample crossing algorithms and results outlined in FIG. 7, and a spread markup of 2 bps or clean price markup of 12 cents should be assumed for all trades to illustrate the profit earned by the CA 150.

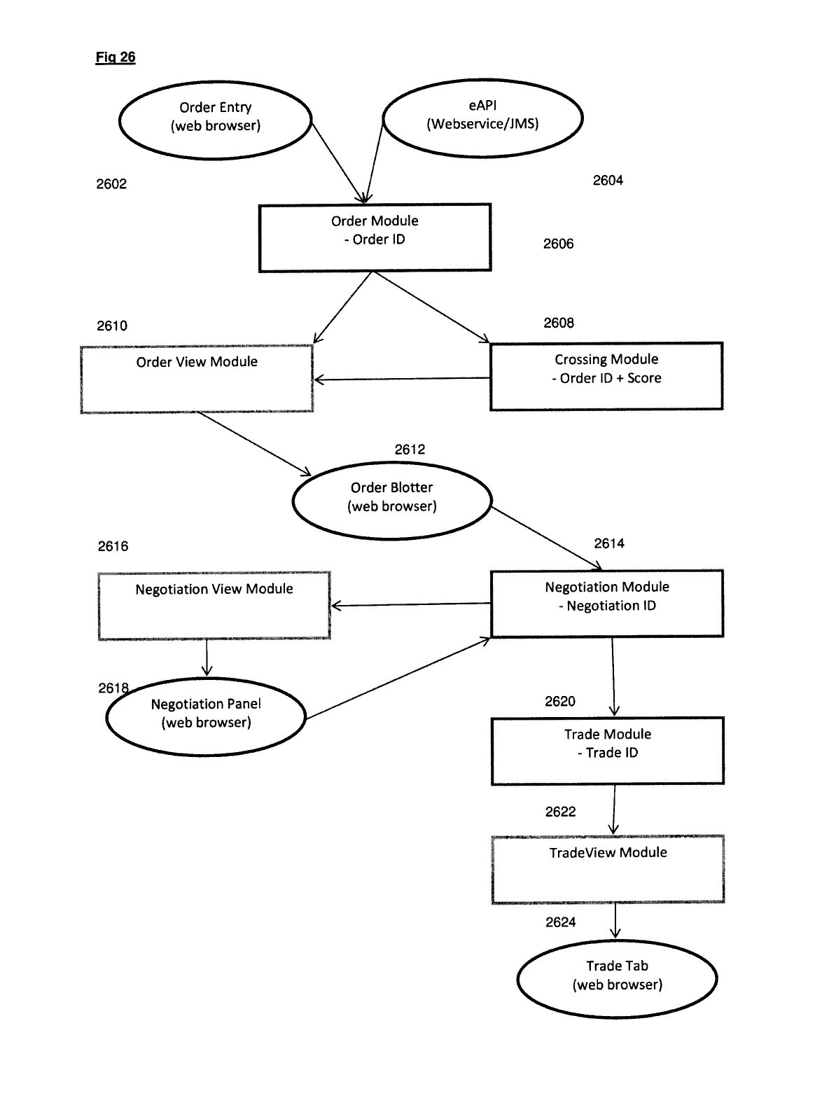

FIG. 26 shows a data flow diagram of the invention showing the process of inputting an order, anonymisation, negotiation and completion of an order.

There is shown, the web-based order entry form 2602 and eAPI web-based entry form 2604, both of which communicate with an order module 2606. The order module 2606 communicates with both a negotiation module 2608 and order view module 2610. The order view module 2610 communicates with a order blotter 2612 which in turn passes data to a negotiation module 2614. The negotiation module 2614 has a negotiation branch comprising a negotiation view module 2616 and negotiation panel 2618, and a trade branch comprising a trade module 2620, trade view module 2622 and trade tab 2624.

An aspect of the invention is to provide one or more clients with a network or internet based trading platform to input orders or offers of financial instruments. FIG. 26 is a data flow diagram of the process of a user (either a buyer or seller) initiating and executing an order for a quantity of a financial instrument.

In use, the user logs-on to the trading platform 100 via a web browser based order entry system 2602 or a thin shell client eAPI 2604 using a login and password system as is known in the art. Once validated, the terminal (either the order entry browser 2602 or thin shell eAPI 2604) is associated with a unique identifier or client ID. The client ID is preferably such that it is not possible for a third party to identify the user via the client ID.

Therefore the term client terminal refers to the interface with the system, which covers both the web browser based system and eAPI.

Users can manage their orders (buying and selling) once logged on. The user inputs information regarding quantity, target price, expiry for length of an active order as well as any comments regarding the financial instruments they are looking to trade (both buying and selling). These inputs therefore identify the financial instrument being traded.

As well as the information regarding the financial instrument, the user may also input the unique identifier associated with the financial instrument. In an embodiment, the international securities identification number (ISIN), which is an internationally recognised code, is used to uniquely identify the financial instruments is inputted. The ISIN allows the financial instrument being traded to be rapidly identified and reduces the amount of information that needs to be inputted.

Advantageously, if the user is looking to purchase an instrument the user may input the ISIN, the attributes regarding the financial instruments (coupon, maturity, currency etc) are identified and automatically filled in. Buyers may also search by the ISIN or alternatively search using the first search facility in the platform to specify the attributes of the financial instrument they are interested in purchasing. Once the ISIN has been inputted or the attributes of the financial instrument have been inputted (quantity, price and the expiry of the order) form the order. The data is then sent from the order entry web browser 2602 or eAPI 2604 to the order module 2606.

The information sent to the order module 2606 includes the aforementioned details of the instrument and quantity, (buy/sell) price and expiry as well as the client ID attributed to the user during the logging in process. Once the information is received by the order module 2606, a unique order identifier is assigned to the order by the order module 2606 and this unique order identifier is associated with the order throughout the lifetime of the order (i.e. until expiry of the order or completion). This association of an individual order with a unique order identifier allows for further anonymisation of the process. The unique order identifier and the details of the order of which it is associated with are stored in a form of secure writable memory in the platform 100.

Users of the system are not presented with the unique order identifier nor the information regarding the financial instrument from other users. Whilst a user may view the instruments they have uploaded to the order universe 110 as well as any orders they have placed via the order view module 2610 (see FIG. 6 and associated description) they are unable to view the instruments uploaded by other users nor the orders placed.

The order ID and information regarding the order (quantity, price and expiry) is then forwarded to the crossing module 2608 and order view module 2610.

In the crossing module 2608, the crossing score is identified for the inputted order as well as all other existing orders in the order universe 110. Therefore for each new order, or new instrument, for sale the propensity for trade between the new order and all other orders in the order universe 110 is calculated.

The crossing scores for the order and the order ID are then sent from the crossing module 2608 to the order viewing module 2610 for presentation to the user.

The information sent to the order view module 2610 consists solely of the unique order identifier and the propensity to trade score as calculated by the crossing module 2608. As new orders are introduced to the order universe and order module 2606, the crossing module 2608 updates the changes to the crossing score (i.e. when new crossing opportunities are available or existing scores are changed due to changes in the order universe), these changes are sent to the order view module 2610 and presented to the user.

The order view module 2610 forwards the relevant order and crossing data to display the information to the clients 160 via the order blotter 2612. The order blotter 2612 is a web-based application, which displays information via a web browser. Advantageously, in order to further anonymise the order universe 110 without revealing the depth of market (number of execution opportunities), the best execution opportunities as determined by the score are presented to the user via the order blotter 2612 in the form of a trade wheel (see FIG. 8 and associated description).

Therefore, throughout the trade execution process, the user 160 is only able to view the orders which they have inputted, and a graphically represented propensity to trade of similar financial instruments, via the order blotter 2612. As stated above, the order blotter 2612 identifies the best execution opportunities and therefore further anonoymises the order universe 110 by only presenting an unknown-to-the-user percentage of the market thereby preventing the user from determining the depth of market. Even when the scores are revealed against the order ID, there is no way for a user to identify the financial instruments as only the crossing score is presented to the user. This minimisation of information presented therefore maintains the anonymity of the user as well as reducing information leakage.

The order blotter 2612 therefore provides users with an interface from which they can initiate negotiations (as a buyer) or complete negotiations (as a seller). As a buyer (or seller) the user can initiate the negotiation on an order which they feels has a high enough propensity to trade scores. The user interacts with the order blotter 2612 in the known manner and selects an instrument to trade based on the cross matching scores. Once a financial instrument is selected for trade, the order blotter 2612 sends the initiating order identifier and responding order identifier to the negotiation module 2614. Therefore, the unique order identifier and the parties involved are forwarded to the negotiation module 2614 to minimise the amount of information sent. The negotiation module creates a new unique negotiation identifier which is assigned to the negotiation process for the particular order. The negotiation identifier itself is unique further ensuring the anonymity of the parties involved and the products being traded.

The negotiation module 2614 facilitates the negotiation and sends the minimum amount of information to be viewed by the buyer and seller by the negotiation module 2616 which is presented on the negotiation panel 2618. The negotiation process (as described below) occurs via the negotiation panel 2618. During the negotiation process, if the quantities offered or requested in an order do not match the clearing agent can choose to consolidate several orders as a single offer. This process is described in detail below.

Anonymity is therefore preserved throughout the negotiation process as neither party is presented with information enabling them to identify each other. During the negotiation process, the seller has the discretion to decide when to display to the buyer the financial instrument which is being traded. The financial instrument must be identified to the buyer at some stage in order for the trade to be completed, however it is only at the seller's discretion, (e.g. when the seller believes a negotiation will be completed) that the financial instrument will be revealed. It is important to note that throughout the process, neither the buyers nor sellers identify is revealed to the other party nor is the quantity or target price of the order revealed to either party. Thus, whilst the financial instrument is revealed during the closing stages of the negotiation process, neither buyer nor seller are aware of the quantities and/or parties involved.

Once the buyers and sellers have successfully negotiated the trade, the information regarding the trade is sent from the negotiation module 2614 to the trade module 2620. The trade module creates a further unique identifier for each leg of the executed negotiation which includes the information pertinent to the executed trade (agreed price, quantity etc). Once completed, the trade view module 2622 forwards the information to the trade tab 2624 for display to the relevant parties. Therefore, it is only at this stage that the relevant parties are presented with information regarding the trade. However, even at this stage the identity of the other party is kept secret.

The assigning of the unique identifiers for each aspect of the trade and negotiation process, ensures that a minimum amount of information is presented to the client 160 at all stages during the trade and negotiation process.

As all identifiers are unique, when trades need to be reported to the relevant financial authorities, the buyers and sellers and the financial instruments involved can be identified. Therefore, the trading platform 100 and the clearing agent represent a trusted relationship between the buyers and the sellers as they ultimately hold and maintain all relevant information to all parties. It will be appreciated, that by only presenting the information to the user via the order blotter 2612, negotiation panel 2618 and trade tab 2624, the potential for leakage of information is minimised.

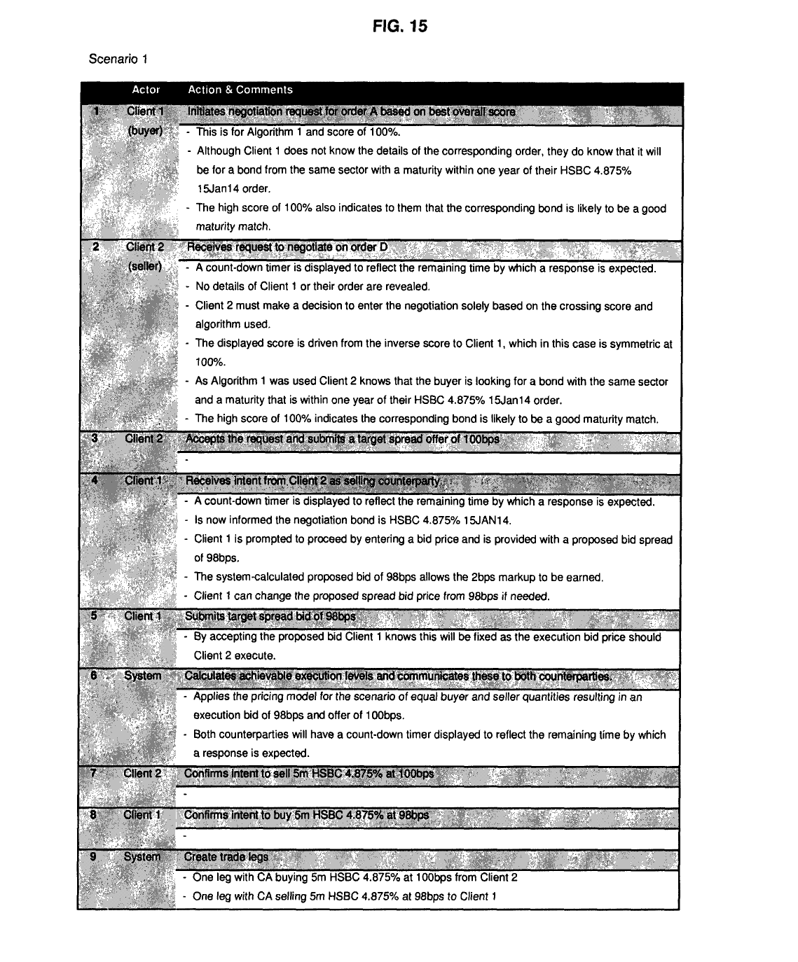

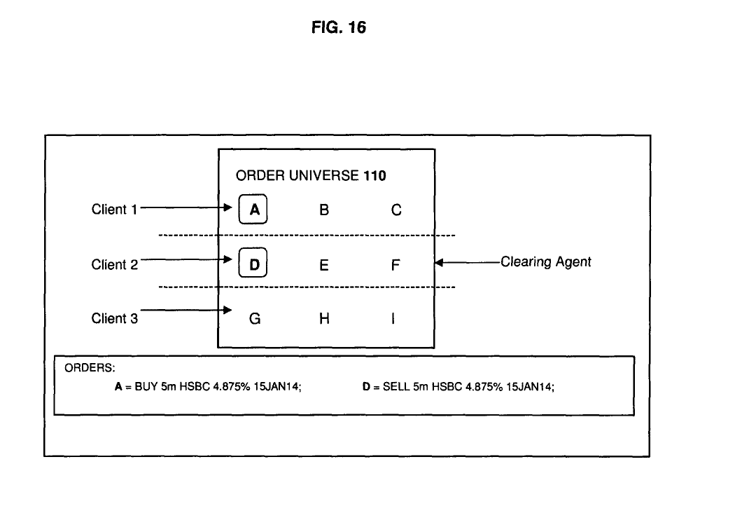

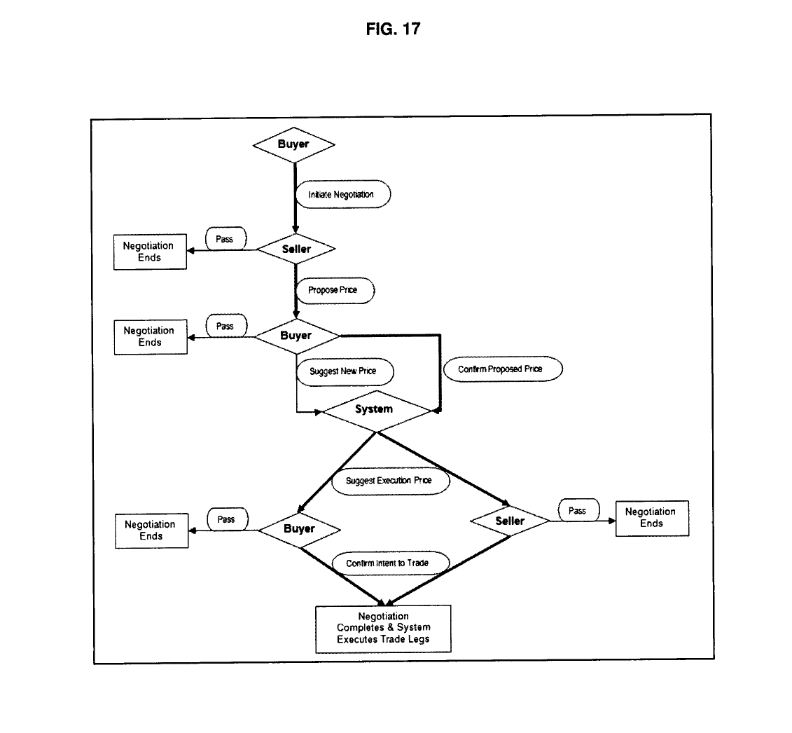

FIG. 15 outlines Scenario 1 between Clients 1 and 2 for orders A and D that have matched with each other as shown in FIG. 16, providing more detail on the thought process behind the negotiation. The buyer and seller quantities are equal at 5 m and in this scenario the buyer initiates the negotiation. FIG. 17 illustrates a flow diagram of Scenario 1 that is described in FIG. 15. The bold arrows denote the path taken by the users as the decisions are made to follow through with the negotiation and complete the trade.

FIG. 17 shows the flowchart of the process of negotiation of a financial instrument between a buyer and seller, wherein the buyer has initiated the negotiations. At step S1702, the buyer has indicated that they wish to initiate the negotiation process. The anonymised offer is sent to the seller who has the option to either pass on the negotiation at step S1704, or to propose a different price at step S1706. If the seller passes on the negotiation at step S1704 then the negotiation ends. If the seller proposes a price at step S1706, it is forwarded to the buyer who has the option to either pass on the negotiation at step S1708 or to continue. There are two branches to the continuation process; either the buyer can confirm the proposed price at step S1710 or suggest a new price at step S1712.

The agreed price is forwarded on to the platform 100 which suggests an execution price at step S1714. The suggested execution price is forwarded to both the buyer and seller who have the option to either accept the trade (at steps S1708 or step S1704 respectively) or to confirm the trade at step S1716. If both buyer and seller have confirmed intent to trade, then the trade is executed and completed at step S1718.

In FIG. 15 the clients have inputted the orders in the order universe shown in FIG. 16. For clarity only 9 orders are shown in the order universe.

In the example shown—This is for Algorithm 1(discussed above) and score of 100%. Whilst Client 1 does not know the details of the corresponding order (as these are anonymised as discussed previously), they do know that it will be for a bond from the same sector with a maturity within one year of their HSBC 4.875% 15Jan14 order. The high score of 100% also indicates to them that the corresponding bond is likely to be a good maturity match. Client 1 initiates negotiation request for order A based on best overall score as presented via the cross matching algorithms (S1702).

Client 2 receives the request to negotiate on order D. A count-down timer is displayed to reflect the remaining time by which a response is expected. As described above no details of Client 1 or their order are revealed. Client 2 must make a decision to enter the negotiation solely based on the crossing score and algorithm used. The displayed score is driven from the inverse score to Client 1, which in this case is symmetric at 100%. As Algorithm 1 was used Client 2 knows that the buyer is looking for a bond with the same sector and a maturity that is within one year of their HSBC 4.875% 15Jan14 order. The high score of 100% indicates the corresponding bond is likely to be a good maturity match. Client 2 indicates via their terminal to accept the request and submits a target spread offer of 100 bps (S1706).

Client 1 receives, via their terminal, notification of intent from Client 2 as selling counterparty. A count-down timer is displayed to reflect the remaining time by which a response is expected. If no response is received within the time-limit and the offer is passed. As the details have regarding the financial instrument been kept anonymous, only at this stage are the details of the instrument are revealed to client 1 who is now informed the negotiation bond is HSBC 4.875% 15JAN14. Therefore, information leakage regarding the order universe is minimised as it is only at this stage details regarding the offered instrument are revealed to client 1. Client 1 is prompted to proceed by entering a bid price and is provided with a proposed bid spread of 98 bps. The system-calculated proposed bid of 98 bps allows the 2 bps markup to be earned. Client 1 can change the proposed spread bid price from 98 bps if needed (S1712).

Client 1 submits target spread bid of 98 bps (S1710). By accepting the proposed bid Client 1 knows this will be fixed as the execution bid price should Client 2 execute. The platform 100 calculates achievable execution levels and communicates these to both counterparties (S1714). The platform applies the pricing model for the scenario of equal buyer and seller quantities resulting in an execution bid of 98 bps and offer of 100 bps (the execution bid and offer calculated vary according to the pricing model applied). Both counterparties will have a count-down timer displayed to reflect the remaining time by which a response is expected. At step S1716 both parties confirm their intent to trade. The platform creates both trade legs Create trade legs with one leg with CA buying 5 m HSBC 4.875% at 100 bps from Client 2 and one leg with CA selling 5 m HSBC 4.875% at 98 bps to Client 1 (S1718).

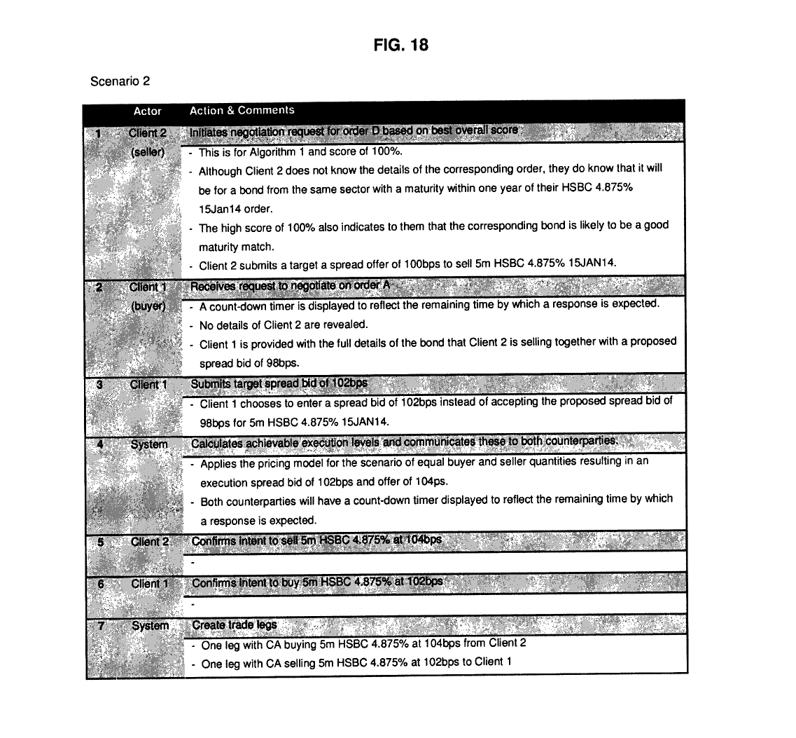

FIG. 18 outlines Scenario 2 again between Clients 1 and 2 for orders A and D that have matched with each other with the order universe shown in FIG. 16. However in this instance Client 2 as the seller initiates the negotiation which produces a different set of paths that the negotiation 130 will take.

Client 2 (the seller) Initiates negotiation request for order D based on best overall score. This is for Algorithm 1 and score of a cross matching of 100%. Although Client 2 does not know the details of the corresponding order, they do know that it will be for a bond from the same sector with a maturity within one year of their HSBC 4.875% 15Jan14 order. Furthermore, the high score of 100% also indicates to them that the corresponding bond is likely to be a good maturity match. Client 2 submits a target spread offer of 100 bps to sell 5 m HSBC 4.875% 15JAN14. Client 1 (the buyer) receives request to negotiate on order A. In order to maintain the anonymous nature of the platform 100 no details of client 2 are revealed to client 1. A count-down timer is displayed on client 1's terminal to reflect the remaining time by which a response is expected. At this stage client 1 is provided with the full details of the bond that Client 2 is selling together with a proposed spread bid of 98 bps.

Client 1 chooses to negotiate and submits target spread bid of 102 bps instead of accepting the proposed spread bid of 98 bps for 5 m HSBC 4.875% 15JAN14. The platform 100 calculates achievable execution levels according to the pricing model and communicates these to both client 1 and 2. The pricing model for the scenario of equal buyer and seller quantities results in an execution spread bid of 102 bps and offer of 104 ps. Both counterparties are presented on their respective terminals their respective offers and a count-down timer which reflects the remaining time by which a response is expected. Client 2 confirms their intent to sell 5 m HSBC 4.875% at 104 bps and Client 1 confirms their intent to buy 5 m HSBC 4.875% at 102 bps. The system create two trade legs to complete the order with one leg with CA buying 5 m HSBC 4.875% at 104 bps from Client 2 and the other leg with CA selling 5 m HSBC 4.875% at 102 bps to Client 1.

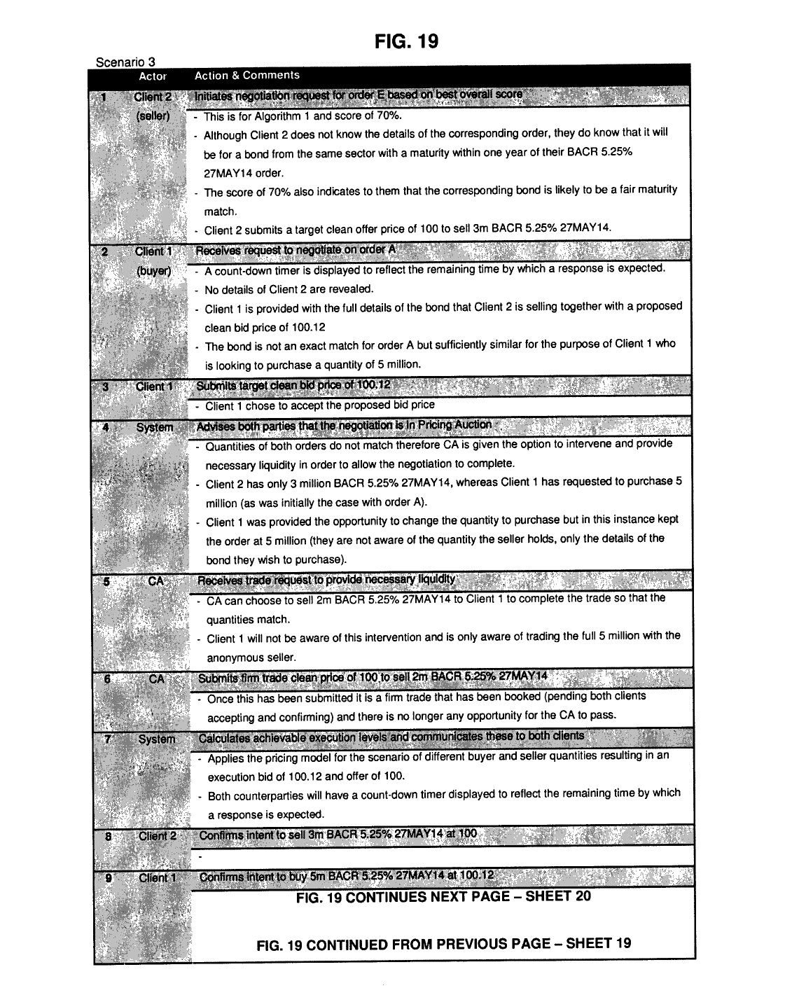

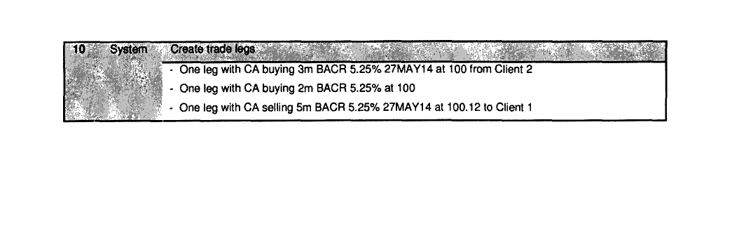

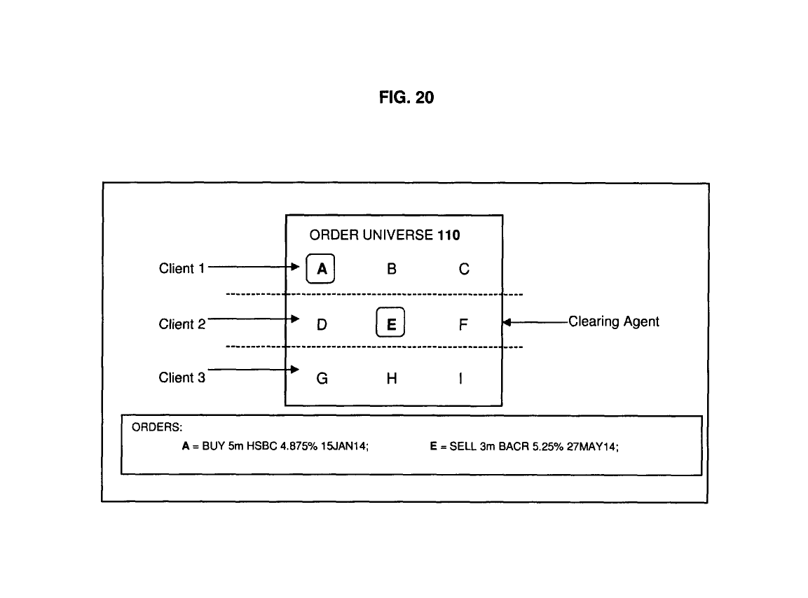

FIG. 19 outlines Scenario 3 between Clients 1 and 2 for orders A and E in the order universe that have matched with each other (see FIG. 20). In this example the buyer and seller quantities are different and so the CA 150 must intervene in order for the negotiation to complete. Therefore, if the CA can intervene to complete the order this allows the completion of an order that ordinarily would not be fulfilled. Thus the CA can consolidate several offers to form a single order. If the CA was to choose not to complete the order and fill the 2 m difference, the negotiation would not complete and both seller and buyer would be notified that a price could not be found to complete the order.

In FIG. 19 client 2 (seller) initiates negotiation request for order E based on best overall score from Algorithm 1 which in this example has score of 70%. Although Client 2 does not know the details of the corresponding order, they do know that it will be for a bond from the same sector with a maturity within one year of their BACR 5.25% 27MAY14 order. Furthermore, the score of 70% also indicates to them that the corresponding bond is likely to be a fair maturity match. Client 2 submits a target clean offer price of 100 to sell 3 m BACR 5.25% 27MAY14. Client 1 (buyer) receives request to negotiate on order A on their terminal. As well as the request a count-down timer is displayed to reflect the remaining time by which a response is expected. To maintain the anonymity of the system no details of Client 2 nor the amount are revealed to client 1. However, in order for the trade to be completed client 1 is provided with the full details of the bond that Client 2 is selling together with a proposed clean bid price of 100.12. In the example, the bond is not an exact match for order A but sufficiently similar for the purpose of Client 1 who is looking to purchase a quantity of 5 million.

Client 1 Submits target clean bid price of 100.12 and chooses to accept the proposed bid price. The platform/system 100 advises both parties, through their respective terminals, that the negotiation is in Pricing Auction. As the quantities of both orders do not match therefore CA is given the option to intervene and provide necessary liquidity in order to allow the negotiation to complete. In the example client 2 has only 3 million BACR 5.25% 27MAY14, whereas Client 1 has requested to purchase 5 million (as was initially the case with order A). Client 1 is provided with the opportunity to change the quantity to purchase but in this instance kept the order at 5 million (In order to maintain anonymity, and to reduce information leakage, they are not aware of the quantity the seller holds, only the details of the bond they wish to purchase).

The CA receives a trade request to provide necessary liquidity. In the example a further 2 m BACR 5.25% 27MAY14 is required and the CA can sell this to Client 1 to complete the trade so that the quantities match. To maintain anonymity Client 1 will not be aware of this intervention and is only aware of trading the full 5 million with the anonymous seller.

If the CA is to intervene the CA submits a firm trade clean price of 100 to sell 2 m BACR 5.25% 27MAY14 (i.e. the amount sufficient to complete the order). Once this has been submitted it is a firm trade that has been booked (pending both clients accepting and confirming) and there is no longer any opportunity for the CA to pass. The platform/system 100 calculates achievable execution levels (according to the pricing model selected) and communicates these to both clients. The pricing model for the scenario of different buyer and seller quantities resulting in an execution bid of 100.12 and offer of 100 which are displayed on the respective terminals. Both counterparties will have a count-down timer displayed to reflect the remaining time by which a response is expected. In this example client 2 confirms intent to sell 3 m BACR 5.25% 27MAY14 at 100 and client 1 confirms intent to buy 5 m BACR 5.25% 27MAY14 at 100.12.

To complete the order the system must create three trade legs: one leg with CA buying 3 m BACR 5.25% 27MAY14 at 100 from Client 2; one leg with CA buying 2 m BACR 5.25% at 100; and one leg with CA selling 5 m BACR 5.25% 27MAY14 at 100.12 to Client 1. The ability for the CA to intervene and provide the further liquidity allows for the trade to be completed, whereas under normal circumstances such orders would remain unfulfilled.

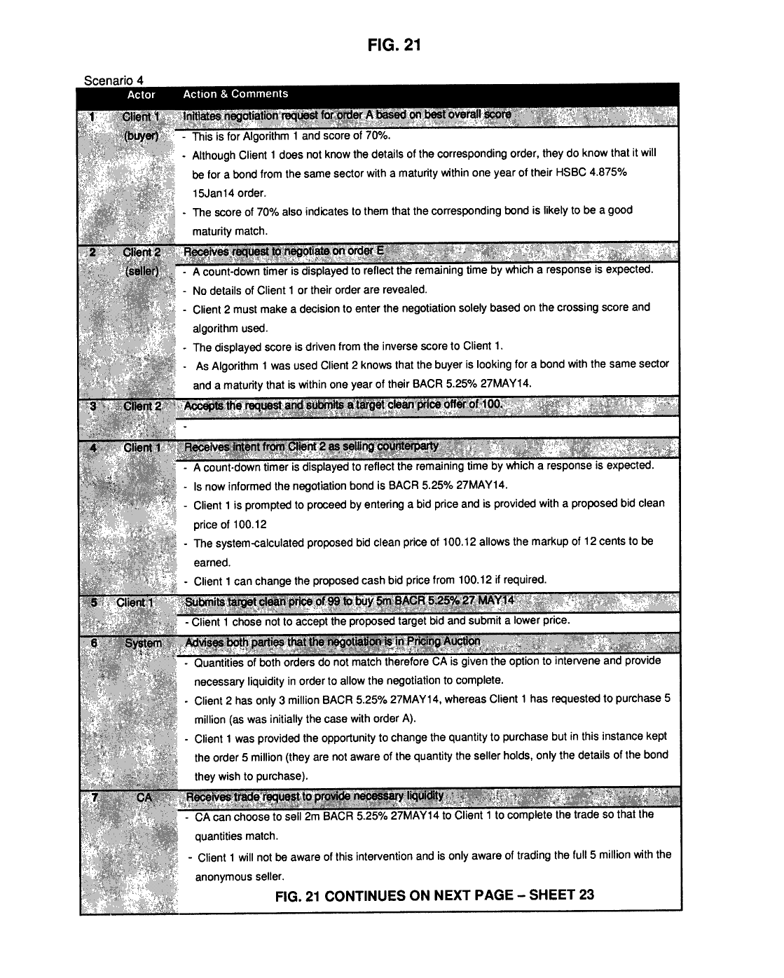

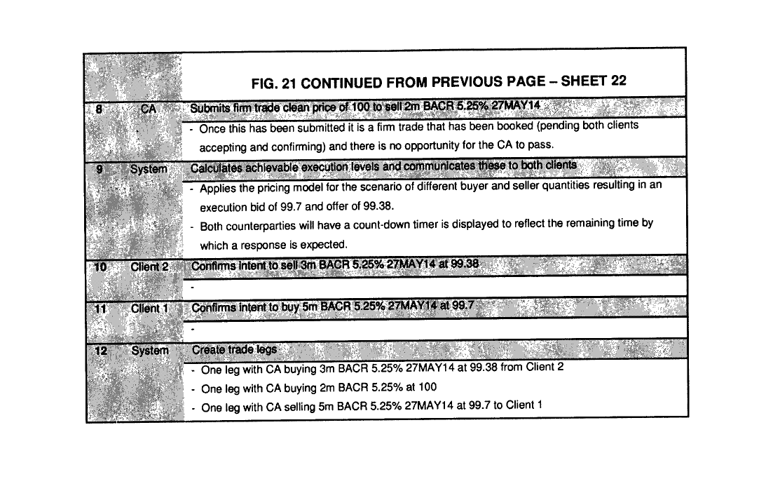

FIG. 21 outlines Scenario 4 between Clients 1 & 2 again for orders A & E that have matched with each other in the order universe shown in FIG. 20. In this example the buyer initiates the negotiation. As the anonymity of the financial instrument is maintained for the longest possible time when a buyer initiates a negotiation they are unsure of what bond will be revealed to them to trade until the seller agrees to proceed with the negotiation. This ensures that only a minimum amount of information is passed between the parties and reduces information leakage.

Client 1 (buyer) Initiates negotiation request for order A based on best overall score, for Algorithm 1 with a cross matching score of 70%. Although Client 1 does not know the details of the corresponding order, they do know that it will be for a bond from the same sector with a maturity within one year of their HSBC 4.875% 15Jan14 order and due to the 7-0% is likely to be a good maturity match.

Client 2 (seller) receives the request to negotiate on order E on their terminal. A count-down timer is displayed to reflect the remaining time by which a response is expected, and as in the other examples to anonymise the trade no details of Client 1 or their order are revealed. Therefore, client 2 makes the decision to enter the negotiation solely based on the crossing score and algorithm used. In this example, as the scores a bidirectional the displayed score is driven from the inverse score to Client 1. As Algorithm 1 was used Client 2 knows that the buyer is looking for a bond with the same sector and a maturity that is within one year of their BACR 5.25% 27MAY14. Client 2 in the example accepts the request and submits a target clean price offer of 100.

Client 1 receives intent from Client 2 as selling counterparty on their terminal with the count-down timer. Client 1 is only now informed the negotiation bond is BACR 5.25% 27MAY14 and is prompted to proceed by entering a bid price and is provided with a proposed bid clean price of 100.12. The system-calculated proposed bid clean price of 100.12 allows the markup of 12 cents to be earned. Client 1 can change the proposed cash bid price from 100.12 if desired. In this example client 1 negotiates and submits target clean price of 99 to buy 5 m BACR 5.25% 27 MAY14. The system 100 advises both parties that the negotiation is in Pricing Auction.

As quantities of both orders do not match therefore CA is given the option to intervene and provide necessary liquidity in order to allow the negotiation to complete. Thus the CA can consolidate several offers to form a single order. In the example client 2 has only 3 million BACR 5.25% 27MAY14, whereas Client 1 has requested to purchase 5 million (as was initially the case with order A). Client 1 is provided the opportunity to change the quantity to purchase but in this instance kept the order 5 million. It is noted that to maintain anonymity client 1 is not aware of the quantity the seller holds, only the details of the bond they wish to purchase. To complete the order the CA receives a trade request to provide necessary liquidity. In such an embodiment the CA consolidates several offers to form a single order. In the present specification individual orders which have been consolidated by the CA are termed offers. As with the previous example the CA can choose to sell 2 m BACR 5.25% 27MAY14 to Client 1 to complete the trade so that the quantities match and to maintain anonymity client 1 is aware of this intervention and is only aware of trading the full 5 million with the anonymous seller.

The CA decides to intervene and submits a firm trade clean price of 100 to sell 2 m BACR 5.25% 27MAY14 and once this has been submitted it is a firm trade that has been booked (pending both clients accepting and confirming) and there is no opportunity for the CA to pass. The system/platform 100 calculates achievable execution levels and communicates these to both clients. The system also applies the pricing model for the scenario of different buyer and seller quantities resulting in an execution bid of 99.7 and offer of 99.38.

Both counterparties will have a count-down timer is displayed to reflect the remaining time by which a response is expected and client 2 confirms intent to sell 3 m BACR 5.25% 27MAY14 at 99.38 and client 1 confirms intent to buy 5 m BACR 5.25% 27MAY14 at 99.7. To complete the trade the system creates three trade legs: one leg with CA buying 3 m BACR 5.25% 27MAY14 at 99.38 from Client 2; one leg with CA buying 2 m BACR 5.25% at 100 and one leg with CA selling 5 m BACR 5.25% 27MAY14 at 99.7 to Client 1. Throughout the process neither client is aware of the CA's intervention nor the other party's identity.

The detailed description of the negotiation lifecycle above together with the above four scenarios demonstrates how the platform's order negotiation 130 differs from conventional models in that the governing principle of the workflow is to achieve execution whilst preserving as much anonymity about the orders involved as possible across the following dimensions:

### 1. Instrument Abstraction

The key platform differentiator is in deviating from the convention based on exact instrument matching and instead moving towards increasing market liquidity by intelligently identifying comparable instruments. In this way the application is able to identify potential execution opportunities that conventional systems cannot, and is especially valuable for markets with a reduced likelihood of finding an exact match such as those where:

Liquidity is fragmented across a large number of unique instruments

Liquidity is fragmented across multiple liquidity sources

Clients are looking for instruments that are not actively traded
The order universe is protected such that clients are only able to see information regarding their orders and the propensity to trade score. Information regarding the instrument being traded is kept anonymous until near the end of the negotiation process.
The instrument specified by a buyer's order is never revealed to a seller as this instrument is not used as the trade instrument for the negotiation and is therefore not needed by the seller for execution. Therefore, information regarding the buyer's intent is only known to the buyer and is never presented to the seller.
The trade instrument is only revealed to the buyer upon receiving either:
A request to enter a negotiation initiated by the seller; or
Intent to enter a negotiation from a seller following an initiation by the buyer.
The use of the unique identifiers during the order process, negotiation and trade process further ensure the anonymity whilst also providing a mechanism for ensuring that all parties in the trade can be identified at a later date to ensure compliance with appropriate financial regulations.

### 2. Counterparty Anonymity

Crossing results do not reveal any information about the owning client for the best scoring orders.
Counterparties are never identified to each other at any point during the negotiation lifecycle, not even after successful execution.
The CA always acts as the counterparty for all generated trade legs and there is no need for counterparties to have existing trading relationships as long as each has one with the CA.
The CA has obligations to its clients to protect their anonymity when dealing with traders and other clients. Appropriate information barriers and protocols should be in place so as not to risk compromising this trust to ensure continued liquidity in the order universe.
As the crossing results are only ever presented by the order blotter 2612 as a trade wheel there is no information leakage associated with the step of presenting the information regarding the propensity to trade to the users.

### 3. Order Universe

The size of the order universe is never revealed to clients and crossing results only reflect the best scores.
The extent of the “best” scores shown to the user can be defined by the CA. By showing scores of instruments which are less well matched the CA may introduce further instruments for consideration for a particular offer whilst maintaining the anonymity of the order universe. It is preferred to only show the highest scores as buyers are often unwilling to trade in instruments with a low propensity to trade score.
Importantly no information on what the instruments the orders are for or the depth of the crossing results are ever presented. As a result clients cannot know if scores across four algorithms are coming from four different orders or if all represent the same order.

### 4. Order Price

The target levels supplied by clients are never revealed to others and the platform provides no means of price discovery for instruments other than through order negotiation. This further ensures the anonymity of the platform and its users.
Order negotiation departs from convention in that price is not expected to play a large role in finding execution opportunities. Although prices can be compared, crossing algorithms are more likely to factor in instrument attributes when calculating scores, as this allows the platform to negotiate on orders without the restriction that both are for the same instrument.

### 5. Order Quantity

By allowing the CA to intervene when quantities are mismatched, the quantity of both orders does not need to be revealed to either party.
This feature limits information leakage as by not revealing the size of the order, inferences cannot be made regarding the other party. Furthermore this increases the available liquidity via CA injections during negotiations, increasing the opportunities for execution by eliminating the restriction for order quantities to be equal in order to trade for those clients that are not interested in partial fills of their orders.

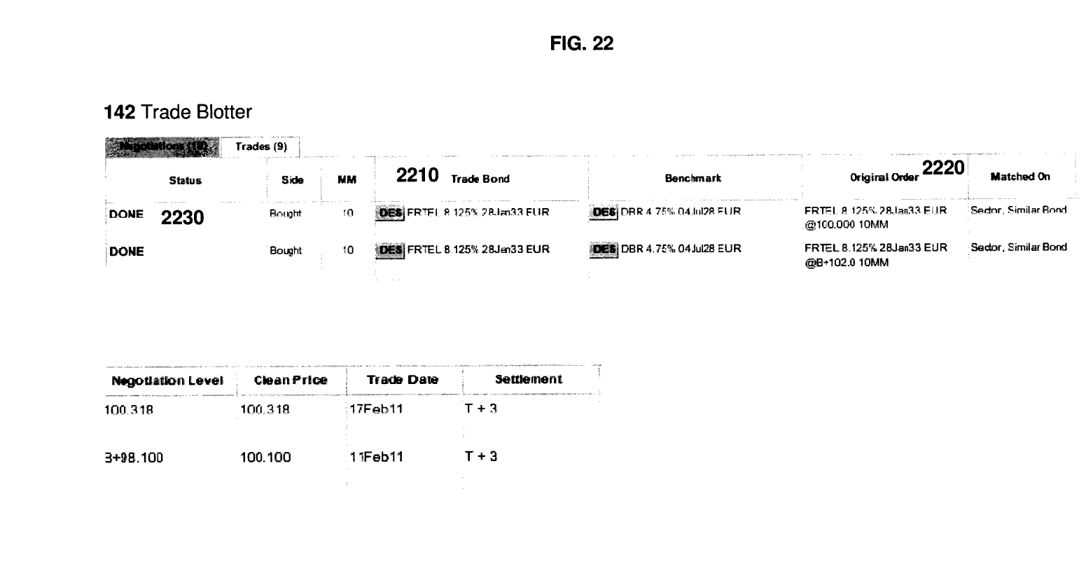

FIG. 22 shows the user interface for the Trade Blotter 142 containing recently executed trades. Full record keeping 140 is preserved in the database 291 while recent trades are displayed showing full details of the bond order that has been traded 2210 together with the original order 2220 the client was looking to action. The status is set to “Done” 2230 when the trade has completed, and the client is provided with full details of the pricing that was achieved for the trade. The original order the client wished to trade is also moved to the Filled Orders tab in the Order Blotter 141.

An important aspect of this invention is the ability for the platform 100 to be configured to support a number of customizable roles as needed to meet the expectations of the CA 150 and it's clients 160 to ensure the system is commercially viable. At a minimum, the following roles have been defined and respective user interfaces have been implemented for each of these roles:

### 1. Client

Clients 160 are the primary users of the application and are individuals that represent an investor to whom the platform 100 is being offered by the CA 150, with which they will have an established and trusted trading relationship.

### 2. Super User

Super users are individuals that represent the CA 150 and who will have full access to all data in the system including profits made for the CA. Super users will also be able to act on behalf of the CA to cover gap positions arising from quantity differences between Clients' 160 buy and sell orders.

### 3. Sales Person

A sales person is an individual who has been granted permission to act on behalf of one or more Clients 160.

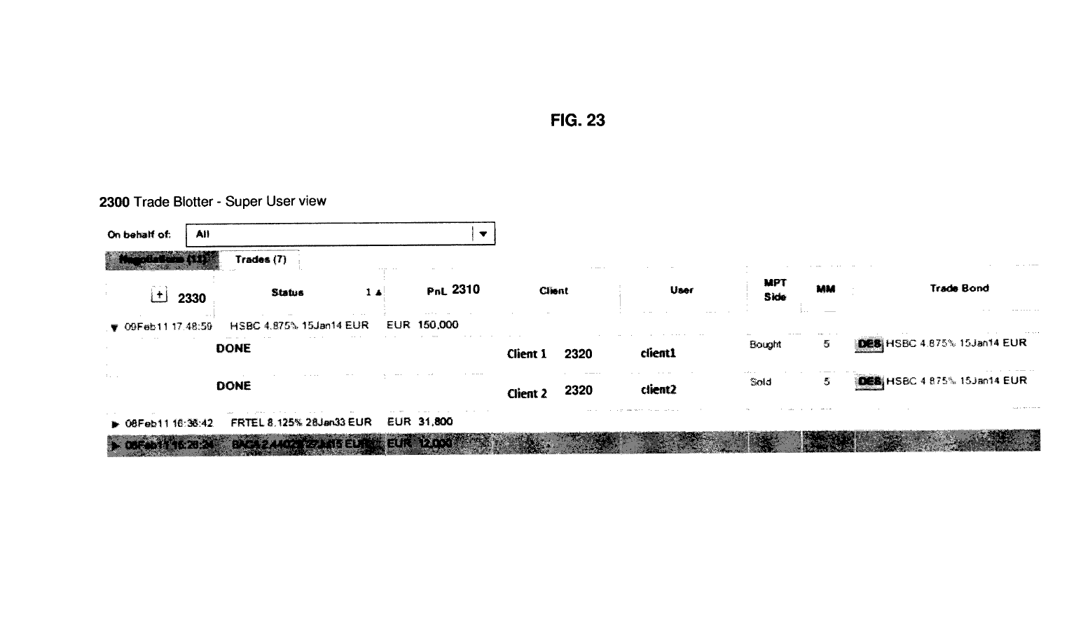

FIG. 23 displays the Trade Blotter for the Super User view 2300, which grants the Super User full access to the data in the platform 100 and provides them with the details of profits made for the CA 150 from each successfully completed negotiation/trade. They are able to see each leg of the trade 2320 that has completed together with the details of which clients traded the bond. Each leg of the trade is grouped by the order that was traded 2330 which is assigned a time stamp of when the negotiation executed. The profit 2310 is calculated over each leg, whether it has two or three legs (where quantities differed for the buyer and seller).

While the above detailed description covers the core value of the software, in order to be commercially viable for use in the real world, the software supports a customizable electronic API (Application Programming Interface) for better integration by the CA 150 with their existing systems that covers the following:

### 1. Instrument Static and Analytics Data Integration

The software data model is designed in a modular fashion with a minimum set of fixed parameters, and where the ability to customize data entities to include additional parameters specific to an instrument asset class or the CA is provided.

### 2. Instrument Analytics Services

This API allows the CA to contribute their own analytics libraries and engines where instrument analytics is desired. This is particularly relevant for instruments that support multiple conventions for expressing price and the system needs to accurately translate between these conventions in order to provide a standardized notation.

### 3. Trade Notification

This API allows the system to electronically inform the CA following trade executions, enabling them for straight through processing by allowing them to feed the trade data to their downstream settlement systems and inform their clients.

### 4. Instrument Pricing Services

This API allows the CA to contribute their own price feeds into the system, where they can be used to drive instrument analytics or to provide indicative price discovery to their clients.

### 5. Notification Services

This API allows the CA to integrate their own notification mechanisms with the platform, allowing the system to leverage any existing infrastructure between the CA and its clients. Supported notification mechanisms include but are not limited to: SMS, email, instant messaging and social networking distribution channels.

### 6. Gateway Adapters

Multiple gateways can be configured that allow the CA or its clients to electronically interact with the platform via an electronic API. Each gateway is responsible for exposing the API in a particular programming language or protocol as understood by the CA and/or its clients, and translating this for processing internally by the system. These gateways are intended to allow the CA and its clients to integrate the platform seamlessly into existing interfaces as opposed to using that of the software.

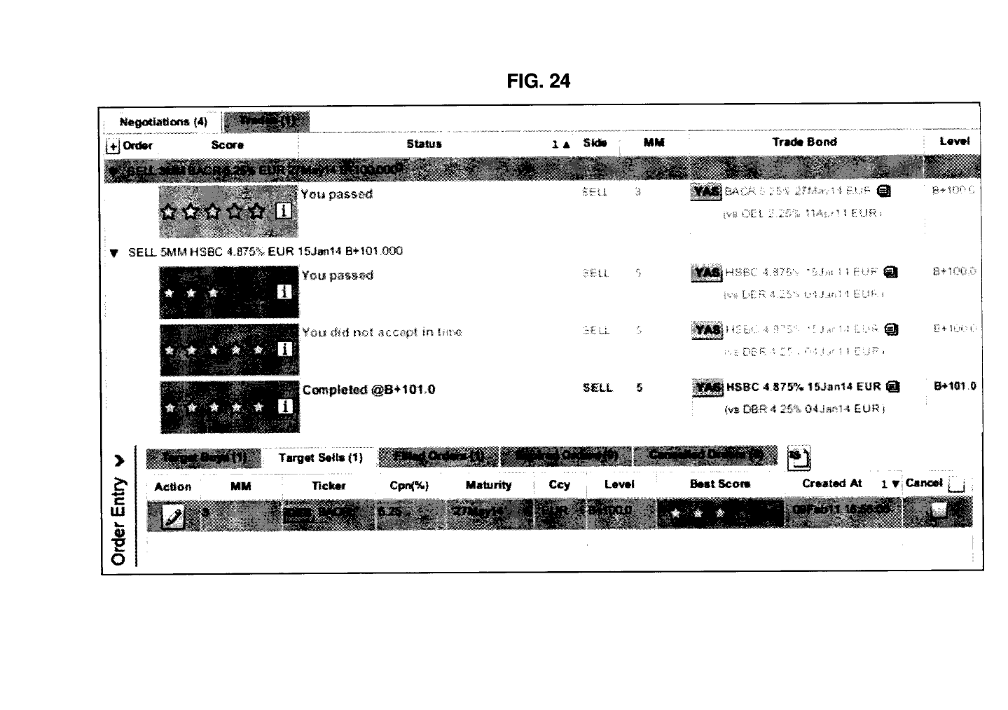

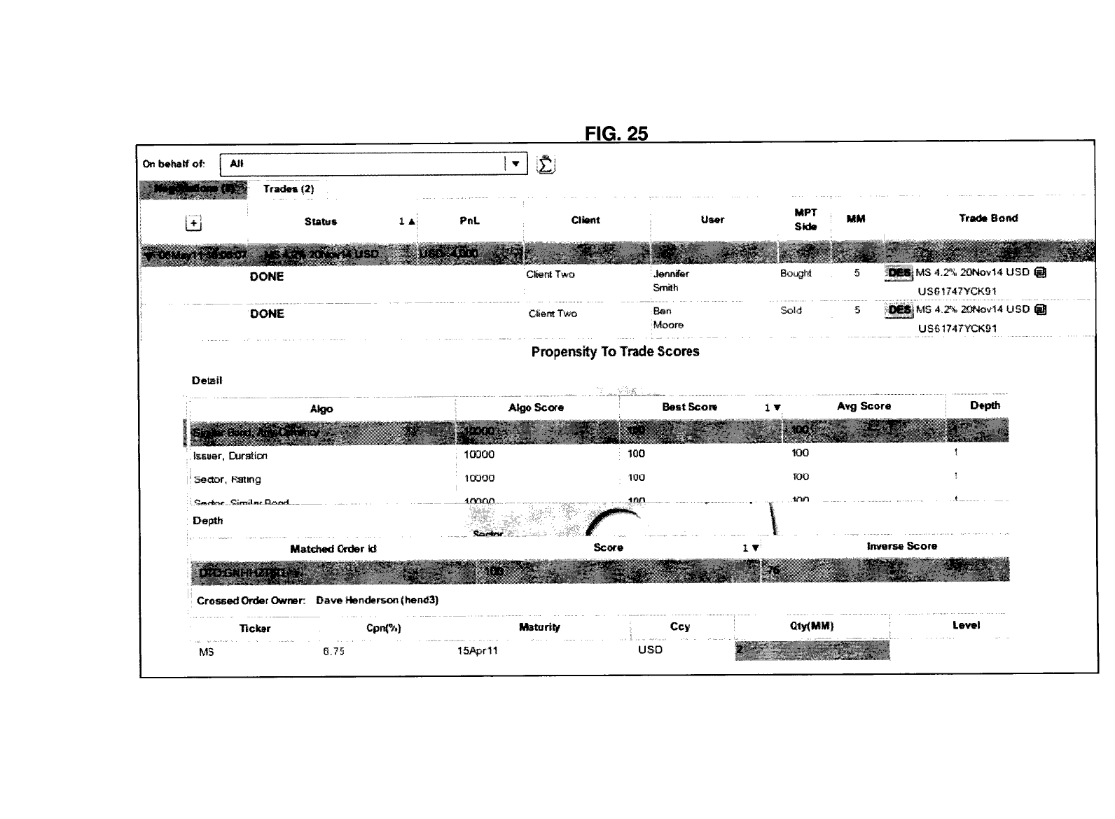

The above detailed description provides full explanation for this invention together with the key features of the various user interfaces. FIG. 24 shows a user interface for the full working view of the platform 100 that a Client 160 will interact with, displaying all the various components on one screen, Order Entry 111, Order Blotter 141, Trade Wheel 123, Negotiation Panel 143 and Trade Blotter 142. For the Super User, the Trade Blotter view 2300 displays profit for the CA 150 too (see FIG. 25).

While the invention has been described in great detail and supplemented with diagrams of various user interfaces, many variations and modifications, as will be evident to those skilled in the relevant arts, may be made without departing from the spirit and scope of the invention. The invention is thus not to be limited to the precise details of methodology or construction set forth above as such variations and modifications are intended to be included within the scope of the invention.

1. A computer implemented method to anonymise transactions conducted via a trading platform including a local area network coupled to at least one server between a clearing agent in communication with a trading database which is stored on a computer readable medium in the trading platform, and a client, the method comprising:
identifying a terminal associated with the client with an anonymised client identifier;
the clearing agent receiving from the client terminal, as an order, a request to buy or sell a quantity of a financial instrument and assigning an anonymised order identifier to the request;
for each anonymised order identifier the trading database identifying financial instruments identical or similar to that requested, and their quantity, offered by a plurality of others for the financial instrument in the request and assigning a weighted score of the likelihood of a match between the identified instruments and the requested instrument;
transmitting via a computer network to the client terminal, as a trade offer anonymised information of the weighted score of the likelihood of a match between the requested and each of a plurality of identified financial instruments; and
receiving from the client terminal via the computer network an indication if one or more of the trade offers is to be negotiated or accepted.

2. The computer implemented method of claim 1 further comprising:
the trading platform further identifying if the quantity of the financial instrument offered matches the quantity requested;
the trading platform consolidating a plurality of orders as a single anonymised offer the quantity of financial instrument requested; and
transmitting to the client terminal as a trade offer the weighted score of the likelihood of a match between the requested financial instrument and the trade offer.

3. The computer implemented method of claim 1 further comprising:
when a trade offer has been indicated as suitable for negotiation assigning an anonymised negotiation identifier to the offer;
transmitting to the client terminal the anonymised order identifier and the weighted score of the likelihood of a match of the offered financial instrument.

4. The method of claim 3 further comprising:
transmitting to the client terminal details regarding the offered financial instrument thereby to enable the user to identify the traded instrument.

5. The method of claim 1 wherein the transmitted weighted scores are in a qualitative form.

6. The method of claim 5 wherein the weighted scores are weighted crossing scores and are segments of a pie chart.

7. The method of claim 1 wherein the weighted scores are calculated using a plurality of crossing algorithms.

8. The method of claim 6 wherein a larger segment size represents a higher crossing score.

9. The method of claim 1 wherein the financial instrument is selected from the group of asset classes consisting of: a stock, a bond, a commodity, a currency, an equity, a derivative security, or a future.

10. The method of claim 9 wherein all financial instruments with the same asset class collectively represent an order universe.

11. The method of claim 10 wherein the trade offer is formed from orders in the order universe.

12. The method of claim 1, further comprising, using clients contributing liquidity on a single or bulk order basis.

13. The method of claim 1 further comprising crossing algorithms to generate the weighted score of the likelihood of a match in a bidirectional manner.

14. The method of claim 13 wherein the crossing algorithms each include at least one of:
comparison of financial instrument static parameters,
comparison of financial instrument analytics parameters, and
comparison of order parameters.

15. The method of claim 1 wherein the weighted score of the likelihood of a trade is calculated when a new order is inputted or an existing order is amended.

16. The method of claim 1 wherein an order negotiation has phases which are:
initiation,
negotiation and
execution.

17. The method of claim 16 wherein the identity of the financial instrument is revealed to a buyer client when:
(a) a request to enter a negotiation is initiated by a seller client, or
(b) an intent to enter a negotiation is indicated by a seller client following an initiation by the buyer client.

18. A computer implemented method for enabling anonymous transactions conducted via a trading platform including a local area network coupled to at least one server between a clearing agent in communication with a trading database which is stored on a computer readable medium in the trading platform, and a client, the method comprising:
the clearing agent receiving from a terminal associated with the client a request for a quantity of a financial instrument as an order;
the trading database identifying financial instruments identical or similar to that requested, and their quantity, offered by a plurality of others and assigning a weighted score of the likelihood of a match between the identified financial instruments and the requested financial instrument;
the trading database further identifying if the quantity of the financial instrument offered matches the quantity requested;
the clearing agent consolidating a plurality of orders as a single anonymised offer the quantity of the financial instrument requested;
transmitting via a computer network to the client terminal as anonymised information, a time limited offer of the requested quantity of identified instruments and the likelihood of a match between the requested and identified financial instruments; and
receiving via the computer network an indication from the client terminal if the time limited offer is to be accepted.

19. A computer trading platform communicating with a clearing agent and a client terminal, the trading platform comprising:
a computer readable memory storing a trading database;
a local area network;
at least one server coupled to the local area network and to the computer readable memory;
the server executing computer instructions to:
identify the client terminal with an anonymised client identifier;
the clearing agent receiving from a client terminal, as an order, a request to buy or sell a quantity of financial instrument and assigning an anonymised order identifier to the request;
for each anonymised order identifier the trading database identifying identical or similar financial instructions, and their quantity, offered by a plurality of other users for the financial instrument in the request and assigning a weighted score of the likelihood of a match between the identified instruments and the requested instrument;
present on the client terminal, as a trade offer anonymised information of the weighted score of the likelihood of a match between the requested and each of a plurality of identified financial instruments; and
indicate via the client terminal if one or more of the trade offers is to be negotiated or accepted.

20. A computer trading platform communicating with a clearing agent and a client terminal, comprising:
a computer readable memory storing a trading database;
a local area network;
at least one server coupled to the local area network and to the computer readable memory;
the server executing computer instructions to:
cause the clearing agent to receive from a client terminal a request for a quantity of financial instrument as an order;
cause the trading database to identify identical or similar financial instructions, and their quantity, offered by a plurality of other users to the financial instrument in the request and assigning a weighted score of the likelihood of a match between the identified instruments and the requested instrument;
cause the trading database to further identify if the quantity of the financial instrument offered matches the quantity requested;
cause the clearing agent to consolidate a plurality of orders as single anonymised offer the quantity of financial instrument requested;
transmit to the client terminal as anonymised information, a time limited offer of the requested quantity of identified instruments and the likelihood of a match between the requested and identified financial instruments; and
receive from the client terminal an indication if the time limited offer is to be accepted.
